(19) United States
(12) Patent Application Publication
(10) Pub. No.: US 2007/0257871 A1
(43) Pub. Date: Nov. 8, 2007

(54) Display Unit

(76) Inventors: Hisashi Watanabe, Tenri-shi (JP); Yozo Narutaki, Yamatokoriyama-shi (JP)

Correspondence Address: NIXON & VANDERHYE, PC, 901 NORTH GLEBE ROAD, 11TH FLOOR, ARLINGTON, VA, 22203, US

(21) Appl. No.: 11/666,219

(22) PCT Filed: Oct. 31, 2005
(86) PCT No.: PCT/JP05/19973

§ 371 Date: Apr. 25, 2007

(30) Foreign Application Priority Data
Nov. 1, 2004 (JP) 2004-318244

(51) Int. Cl. G09G 3/34

(52) U.S. Cl. 345/84

(57) ABSTRACT

The display apparatus of the present invention includes a plurality of condensing elements 54a provided between a lighting device and a display panel 100. A first substrate 10 of the display panel 100 is placed on the side of a display medium layer 23 facing the lighting device while the second substrate 11 is placed on the observer side thereof. Each pixel element Px has a transmission region Tr for display in the transmission mode using light 41 incident from the lighting device, and the first substrate 10 has a transparent electrode region defining the transmission region Tr on the side facing the display medium layer 23. Each condensing element 54a is placed to correspond to the transmission region Tr of the pixel element Px so as to form the converging point of light outputted from the lighting device at a position closer to the observer with respect to the display medium layer 23. The present invention improves the use efficiency of light from the lighting device and enhances the luminance without constraints of arrangement of pixel elements and the like.

### TECHNICAL FIELD

The present invention relates to a display apparatus and more particularly to a non-light emitting type display apparatus using light from a lighting device for display.

### BACKGROUND ART

Non-light emitting type display apparatuses include liquid crystal display apparatuses, electrochromic display apparatuses, electrophoresis display apparatuses and the like. Among others, liquid crystal display apparatuses have found widespread application in personal computers, mobile phones and the like, for example.

A liquid crystal display apparatus is configured to change the optical characteristics of portions of a liquid crystal layer corresponding to pixel element apertures by applying a drive voltage to pixel element electrodes arranged regularly in a matrix, to thereby display images, characters and the like. To control a plurality of pixel elements individually, the liquid crystal display apparatus is provided with thin film transistors (TFTs) for the respective pixel elements as switching elements. Also provided are interconnects for supplying a predetermined signal to the switching elements.

With such a transistor provided for each pixel element, however, the area of the pixel element decreases and this causes a problem of decrease in luminance.

Another problem is that it is difficult to form switching elements and interconnects having sizes smaller than some limits because of constraints of their electrical performance, fabrication technology and the like. For example, the etching accuracy in photolithography has a limit of about 1 μm to 10 μm. Therefore, as the pitch of pixel elements becomes smaller with attainment of higher definition and smaller size in the liquid crystal display apparatus, the aperture ratio further decreases and the problem of decrease in luminance becomes noticeable.

To solve the problem of decrease in luminance, there are disclosed methods in which a condensing element is provided for each pixel element of a liquid crystal display apparatus to condense light on each pixel element.

For example, Patent Literature 1 discloses a semi-transmissive (transmissive/reflective) liquid crystal display apparatus having transmission regions and reflection regions, in which condensing elements such as microlenses are provided.

The semi-transmissive liquid crystal display apparatus has recently been developed as a liquid crystal display apparatus suitably usable even in a bright environment, such as that for a mobile phone, for example. In the semi-transmissive liquid crystal display apparatus, each pixel element has a transmission region for display in the transmission mode using light from a backlight and a reflection region for display in the reflection mode using ambient light. The transmission-mode display or the reflection-mode display can be switched, or display in both modes can be made, depending on the use environment.

The semi-transmissive liquid crystal display apparatus has the following problem: since wide reflection regions to some extent must be secured, the area ratio of the transmission region to each pixel element decreases, and this decreases the luminance in the transmission mode.

To address the above problem, Patent Literature 2 discloses the following method. In a semi-transmissive liquid crystal display apparatus in which reflectors having openings and condensing elements such as microlenses are provided on a substrate placed on the backlight side, the reflectors and the microlenses are placed on the same surface of the substrate that faces a liquid crystal layer. With this placement, light from the backlight incident on the microlenses is condensed on the openings of the reflectors with high efficiency.

Patent Literature 3 discloses the following method. Microlenses have a circular or hexagonal bottom shape, and the microlenses and transmission regions of pixel elements are arranged in a zigzag pattern. Also, the microlenses and the transmission regions are made to have 1:1 correspondence therebetween, and are placed so that the focus of each microlens falls at the center of the transmission region of the corresponding pixel element, to thereby enhance the light condensing efficiency (use efficiency of light incident from a lighting device) with the microlenses.

Patent Literature 4 discloses a method in which collimate elements for narrowing the angle of divergence of light (diffused light) outputted from a lighting device, that is, producing near parallel light rays is provided, to thereby enhance the light condensing efficiency with microlenses.

In the above pieces of Patent Literature, the converging point of light passing through each microlens is formed in a transparent electrode region on a first substrate such as an active matrix substrate (Patent Literature 2 and 3) or in the portion of the liquid crystal layer in a pixel element (Patent Literature 4).

Patent Literature 1: Japanese Laid-Open Patent Publication No. 11-109417

Patent Literature 2: Japanese Laid-Open Patent Publication No. 2002-333619

Patent Literature 3: Japanese Laid-Open Patent Publication No. 2003-255318

Patent Literature 4: Japanese Laid-Open Patent Publication No. 2001-154181

### DISCLOSURE OF INVENTION

### Problems to be Solved by the Invention

As described above, a variety of methods have been proposed for enhancing the luminance of a display apparatus by condensing light incident from a lighting device on each pixel element with a condensing element such as a microlens. However, the light condensing efficiency with a microlens is not yet sufficient.

Although a semi-transmissive liquid crystal display apparatus was exemplified in the above description, transmissive liquid crystal display apparatuses share the desire for improving the use efficiency of light from a lighting device. This desire is also shared by non-light emitting display apparatuses other than liquid crystal display apparatuses.

In view of the above, a main object of the present invention is providing a display apparatus in which the use efficiency of light from a lighting device is improved to attain enhanced luminance.

### Means for Solving the Problems

The display apparatus of the present invention includes: a lighting device for outputting light to the front; a display panel provided with a plurality of pixel elements arranged in a matrix; and a plurality of condensing elements provided between the lighting device and the display panel, wherein the display panel includes a first substrate, a second substrate and a display medium layer placed between the first substrate and the second substrate, the first substrate being placed on the side of the display medium layer facing the lighting device, the second substrate being placed on the observer side of the display medium layer, each of the plurality of pixel elements has a transmission region for display in a transmission mode using light incident from the lighting device, the first substrate having a transparent electrode region defining the transmission region on the side facing the display medium layer, and each of the plurality of condensing elements is placed to correspond to the transmission region of each of the plurality of pixel elements and placed so as to form the converging point of light outputted from the lighting device at a position closer to the observer with respect to the display medium layer.

In a preferred embodiment, the ratio (d/f) of a distance d from the top of the condensing element to the transparent electrode region to a distance f from the top of the condensing element to the converging point satisfies 0.6≦(d/f)≦0.9.

In another preferred embodiment, the ratio (d/f) of a distance d from the top of the condensing element to the transparent electrode region to a distance f from the top of the condensing element to the converging point satisfies 0.7≦(d/f)≦0.8.

In yet another preferred embodiment, the ratio (f/P1) of a distance f from the top of the condensing element to the converging point to a pitch P1 of the plurality of pixel elements in the row direction satisfies (f/P1)<6.

In yet another preferred embodiment, the positions of light condensing spots formed for two pixel elements adjacent in the row direction, among the plurality of pixel elements, are different from each other in the column direction.

In yet another preferred embodiment, the plurality of condensing elements constitute a microlens array.

In yet another preferred embodiment, each of the plurality of pixel elements further has a reflection region for display in a reflection mode using light incident from the observer side, the first substrate having a reflection electrode region defining the reflection region on the side facing the display medium layer, the first substrate further has a plurality of data signal lines arranged in the row direction, each of the plurality of pixel elements is placed between two data signal lines adjacent to each other, and at least one of a pair of sides of the two data signal lines adjacent to each other, the pair of sides facing each other via a pixel element, forms a concave portion dented in the row direction, and at least part of the transparent electrode region is formed at a position corresponding to the concave portion.

In yet another preferred embodiment, the first substrate has a transparent electrode and a reflection electrode having an opening placed on the side of the transparent electrode facing the display medium layer, the transparent electrode region being defined by the opening of the reflection electrode, and the transparent electrode has a convex portion part of which is located inside the concave portion.

In yet another preferred embodiment, a pair of sides of the two data signal lines adjacent to each other, the pair of sides facing each other via a pixel element, form a pair of concave portions dented in the row direction, and the transparent electrode region is formed at a position corresponding to the pair of concave portions.

In yet another preferred embodiment, the positions of transmission regions of two pixel elements adjacent in the row direction, among the plurality of pixel elements, are different from each other in the column direction, and the reflection electrode of a given pixel element has a cut at a position corresponding to the transmission region of a pixel element adjacent in the row direction.

In yet another preferred embodiment, each of the plurality of pixel elements further has a reflection region for display in a reflection mode using light incident from the observer side, the first substrate having a reflection electrode region defining the reflection region on the side facing the display medium layer, the first substrate further has a plurality of data signal lines arranged in the row direction, each of the plurality of pixel elements is placed between two data signal lines adjacent to each other, and the two data signal lines adjacent to each other have a portion curved so that the distance therebetween is wider than in the other portions, and at least part of the transparent electrode region is formed at a position corresponding to a concave portion formed by the curved portion.

In yet another preferred embodiment, the first substrate has a transparent electrode and a reflection electrode having an opening placed on the side of the transparent electrode facing the display medium layer, the transparent electrode region being defined by the opening of the reflection electrode, and the transparent electrode has a convex portion part of which is located inside the concave portion formed by the curved portion.

In yet another preferred embodiment, the positions of transmission regions of two pixel elements adjacent to each other in the row direction, among the plurality of pixel elements, are different from each other in the column direction, and the reflection electrode of a given pixel element has a cut at a position corresponding to the transmission region of a pixel element adjacent in the row direction.

In yet another preferred embodiment, the parallelism of light outputted from the lighting device and incident on the plurality of condensing elements is ±5° or less in half-value angle.

In yet another preferred embodiment, the display medium layer is a liquid crystal layer.

In yet another preferred embodiment, the display apparatus further includes a light diffusion element placed on the observer side of the display medium layer.

The mobile electronic equipment of the present invention includes any of the display apparatuses described above.

### EFFECT OF THE INVENTION

According to the display apparatus of the present invention, each of the condensing elements placed between the lighting device (backlight) and the display panel is configured to form the converging point of light outputted from the lighting device at a position closer to the observer with respect to the display medium layer. The light use efficiency is therefore enhanced.

Also, according to the present invention, in a semi-transmissive display apparatus having transmission regions for display in the transmission mode and reflection regions for display in the reflection mode, the area of the transparent electrode region defining each transmission region can be increased by partially adjusting the width of the data signal lines and the distance between two adjacent data signal lines. Therefore, the aperture ratio of the transmission regions is further improved, and thus the luminance of transmission-mode display is enhanced. In particular, the luminance of transmission-mode display can be improved by arranging the transparent electrode regions in a zigzag pattern.

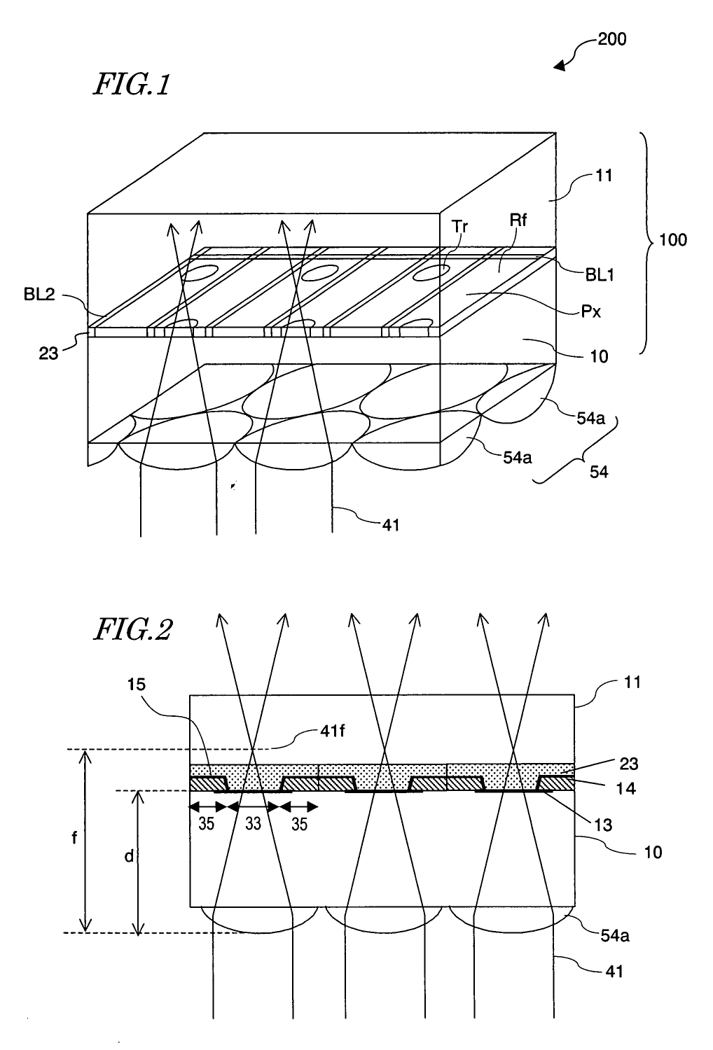

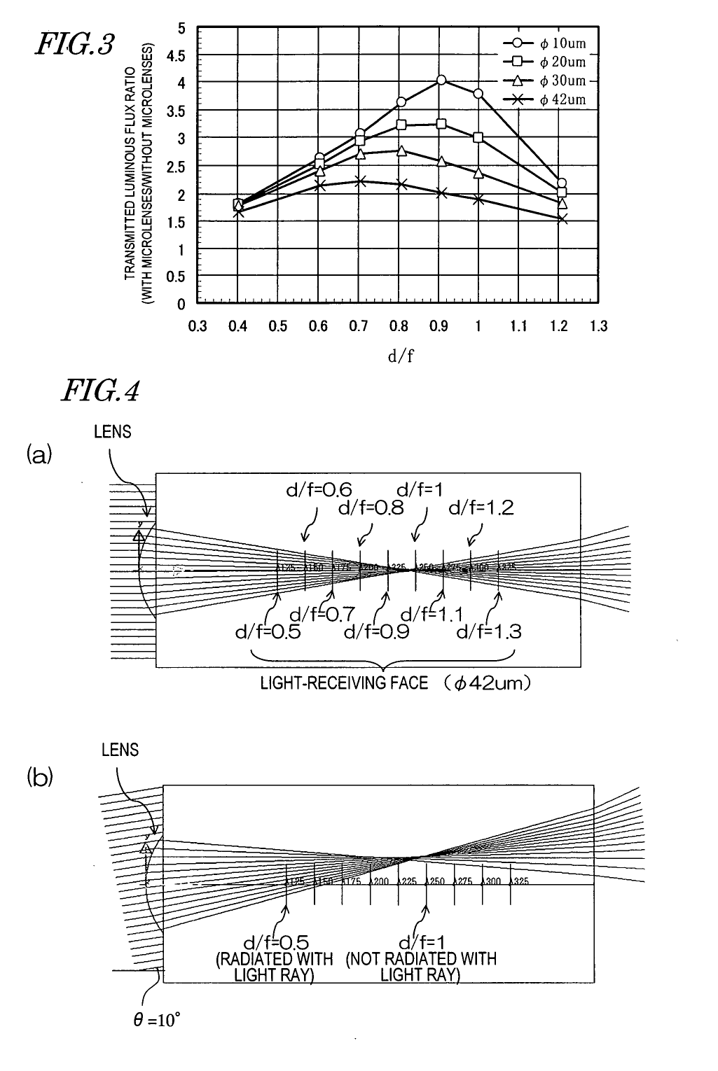

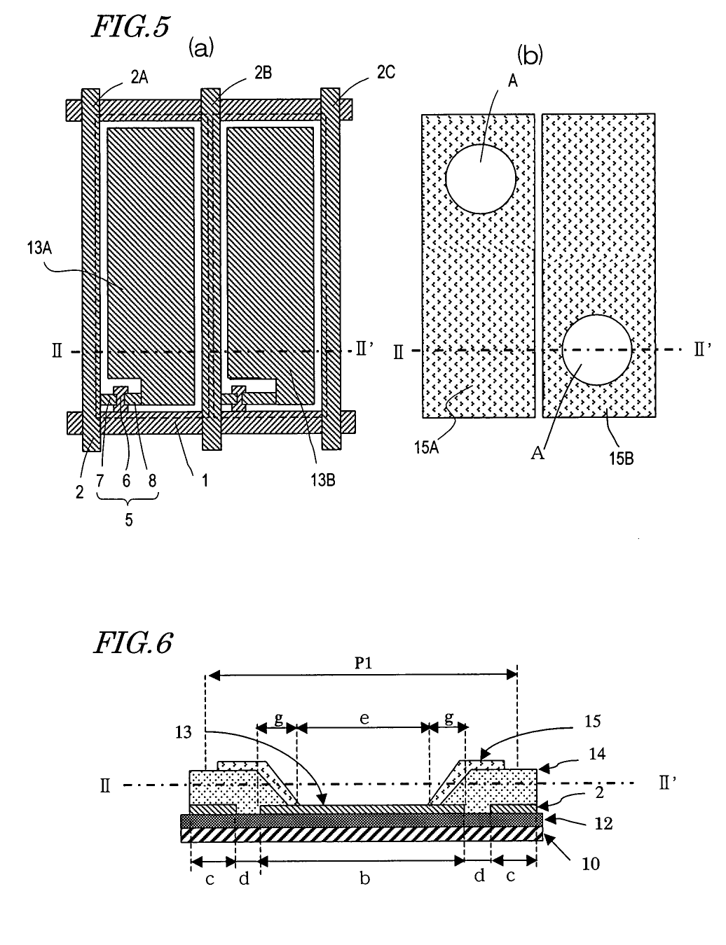

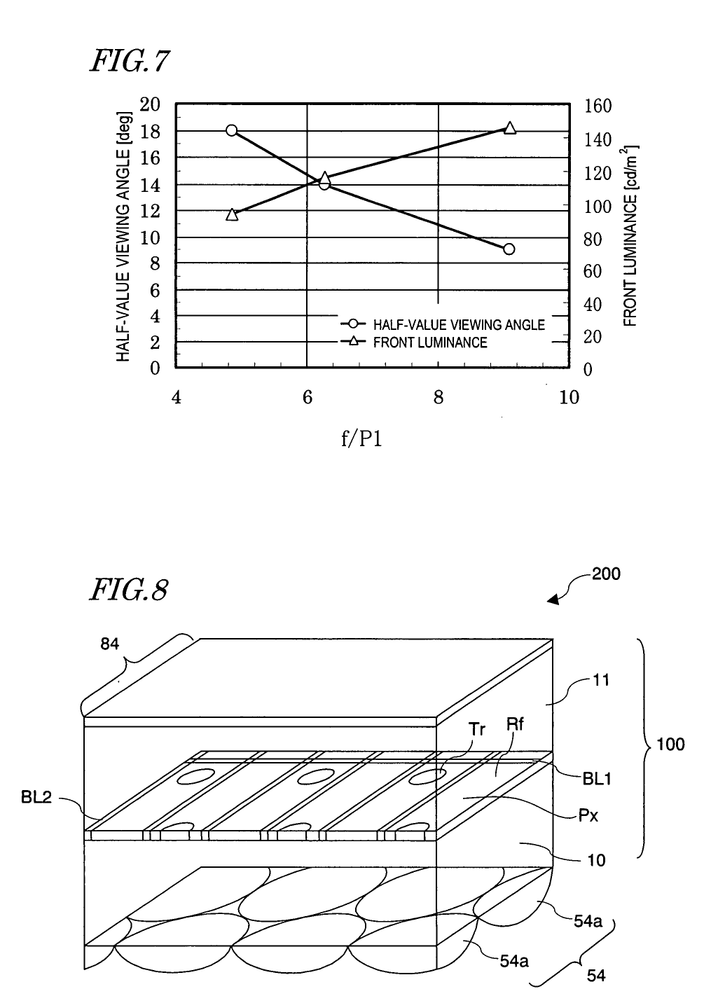

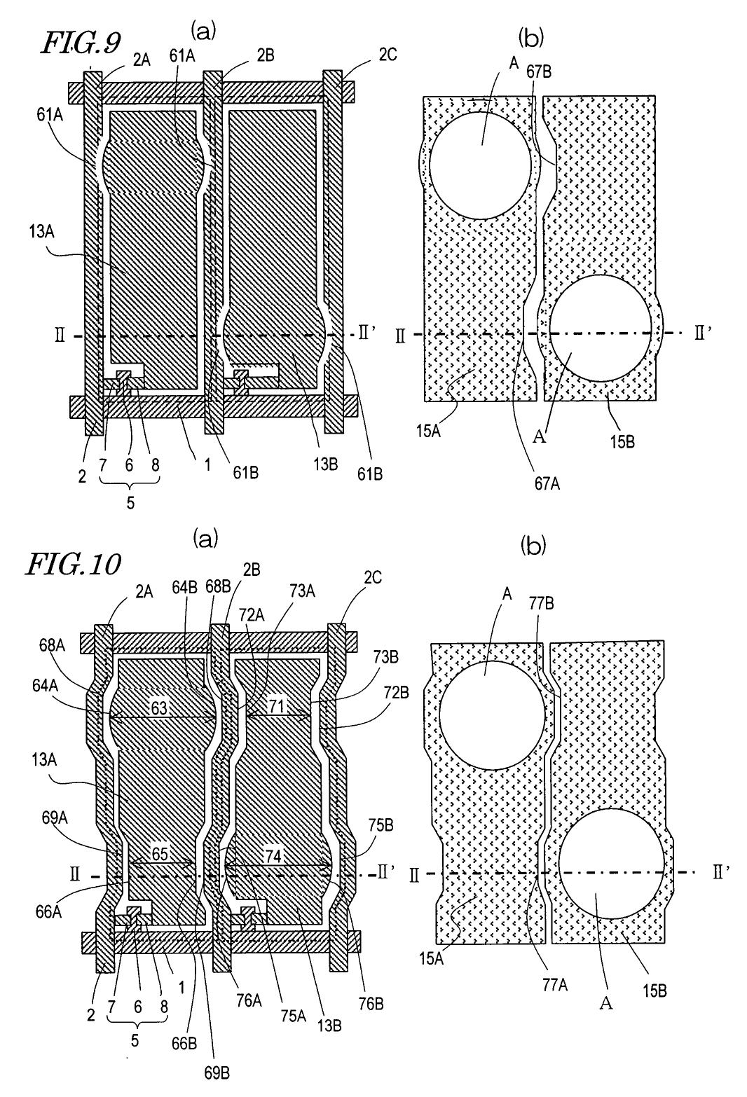

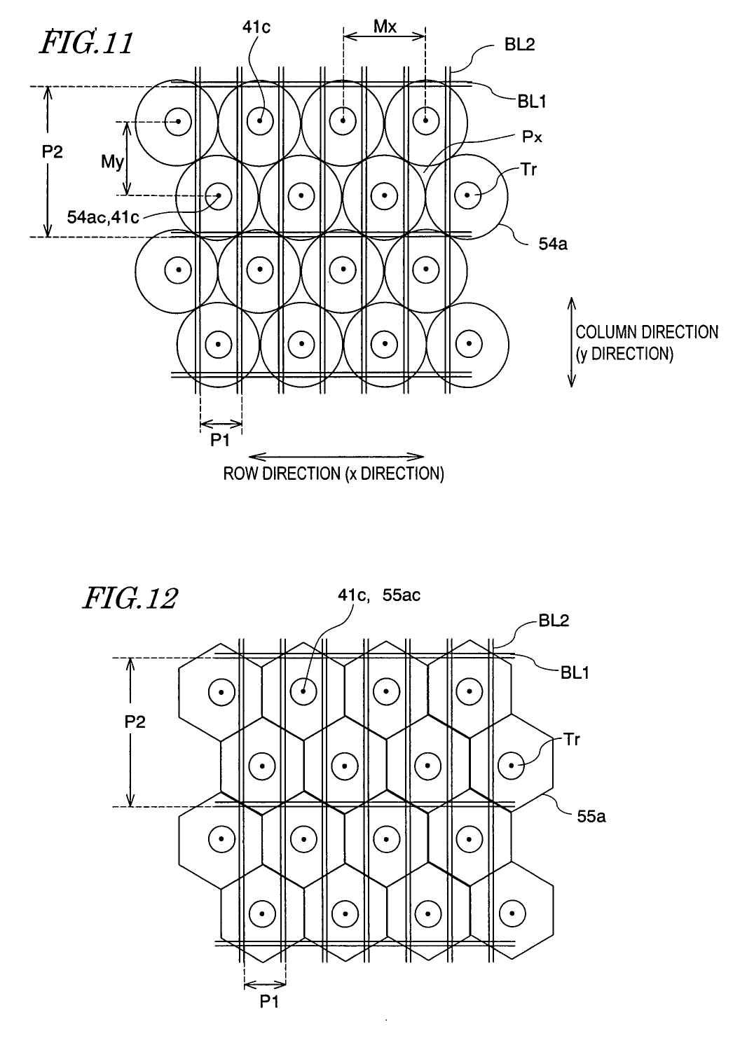

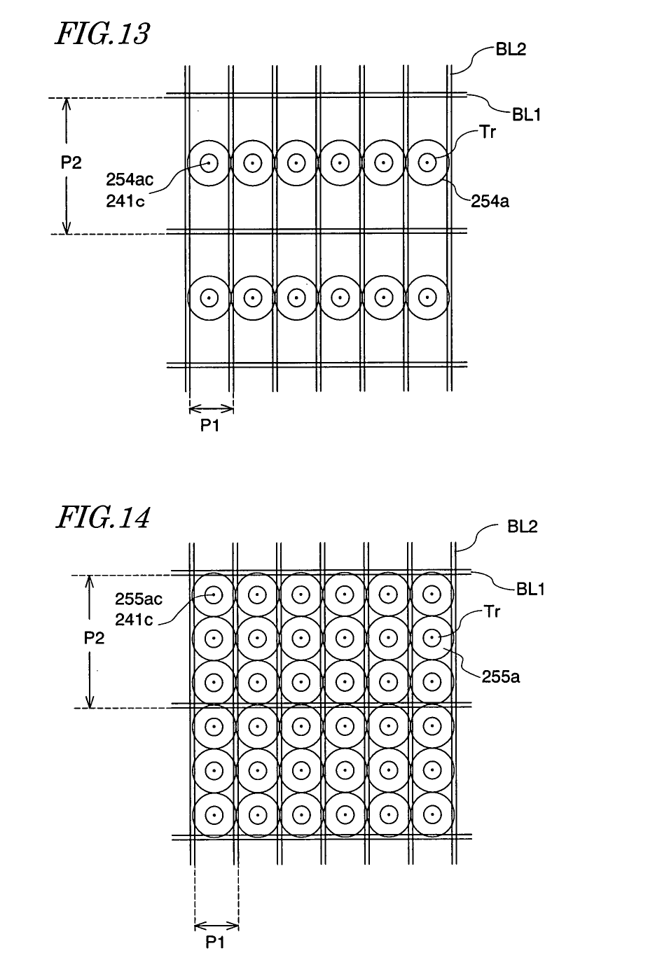

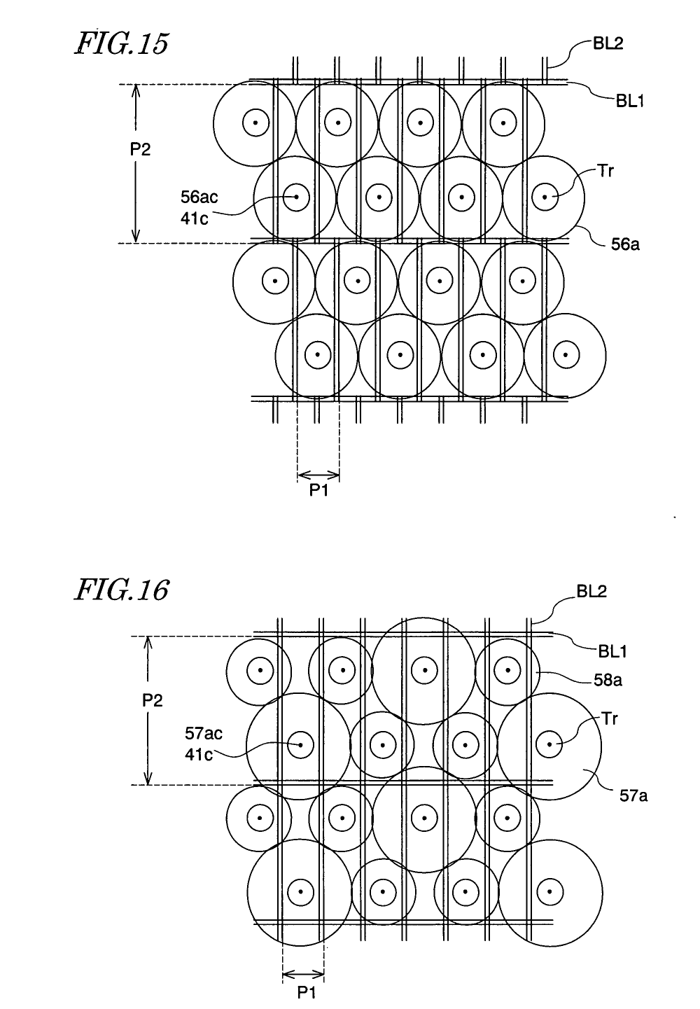

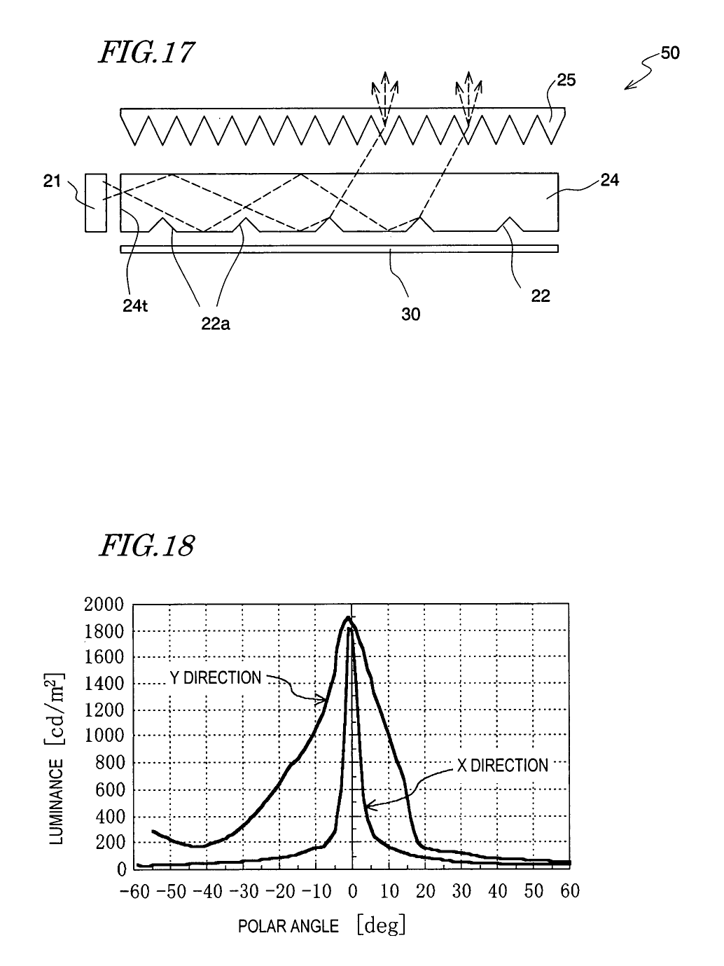

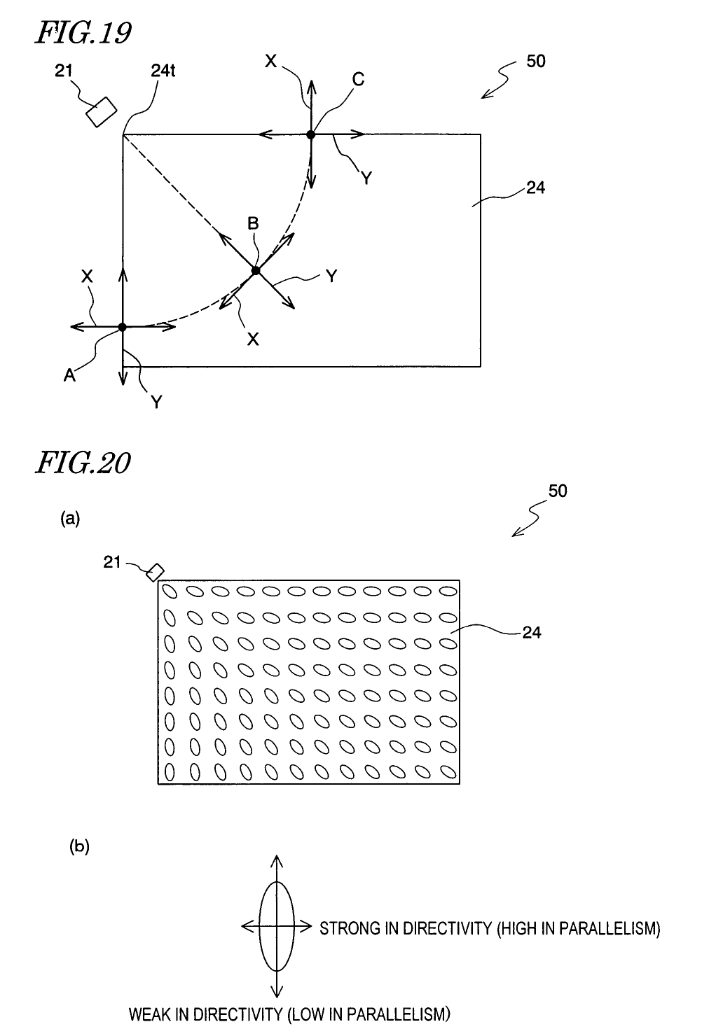

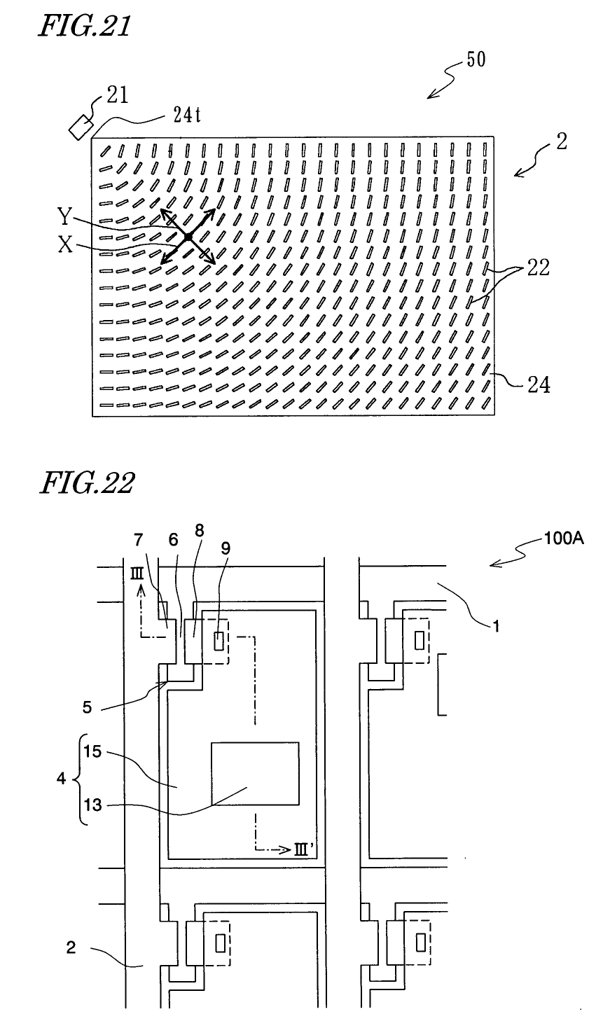

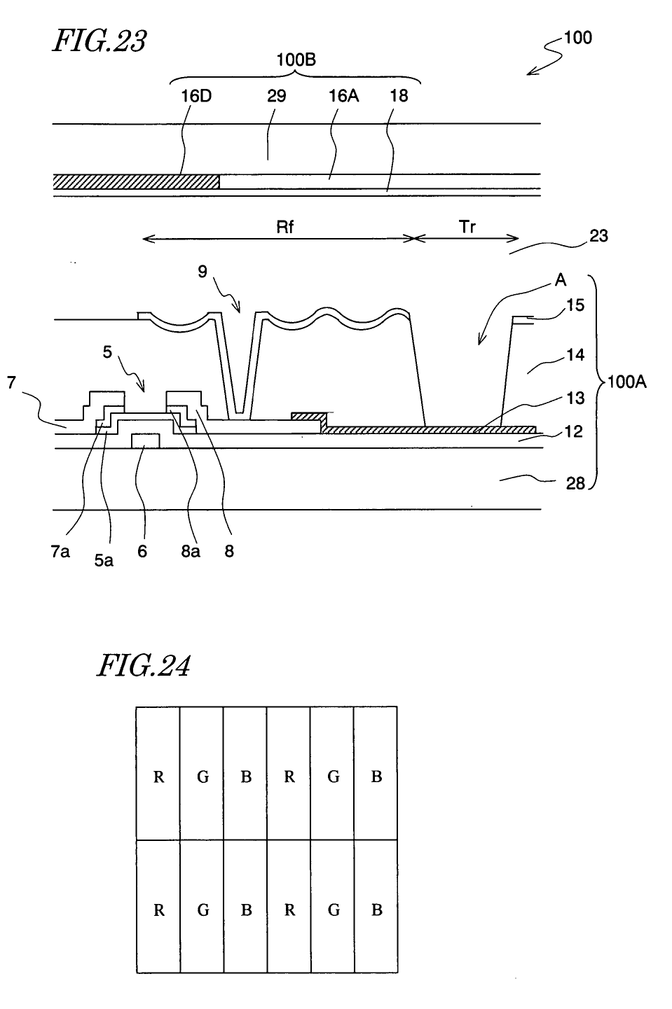

### BRIEF DESCRIPTION OF DRAWINGS

[FIG. 1] A perspective view diagrammatically showing a semi-transmissive liquid crystal display apparatus used as Embodiment 1.

[FIG. 2] A diagrammatic view for explaining the focus position (position of the converging point) of a microlens in the display apparatus of FIG. 1.

[FIG. 3] A graph showing the results of examination on the relationship between the transmitted luminous flux and (d/f) when (d/f) is changed in the range of about 0.4 to 1.2.

[FIG. 4] (a) A diagram of light rays observed when complete parallel light is incident on a microlens, and (b) A diagram of light rays observed when light tilting by 10° from the normal to a microlens is incident on the microlens.

[FIG. 5] (a) A plan view illustrating a TFT substrate of the display apparatus of Embodiment 1, and (b) A plan view illustrating a reflection electrode defining a reflection electrode region on the TFT substrate shown in (a).

[FIG. 6] A cross-sectional view of the TFT substrate taken along line II-II′ in FIGS. 5(a) and 5(b).

[FIG. 7] A graph showing the relationships between the ratio (f/P1) of the distance f from the top of a condensing element to the converging point to a pitch P1 of pixel elements in the row direction and the half-value viewing angle and between the ratio (f/P1) and the front luminance.

[FIG. 8] A perspective view of the semi-transmissive liquid crystal display apparatus used as Embodiment 1 with refracting elements further placed on the observer side of a display medium layer.

[FIG. 9] (a) A plan view illustrating a TFT substrate of a display apparatus of Embodiment 2, and (b) A plan view illustrating reflection electrodes defining reflection electrode regions on the TFT substrate shown in (a).

[FIG. 10] (a) A plan view illustrating a TFT substrate of a display apparatus of Embodiment 3, and (b) A plan view illustrating reflection electrodes defining reflection electrode regions on the TFT substrate shown in (a).

[FIG. 11] A plan view diagrammatically showing a desired example of the positional relationship between the centers of microlenses and light condensing spots and the corresponding transmission regions in the liquid crystal display apparatus of FIG. 1.

[FIG. 12] A plan view diagrammatically showing another desired example of the positional relationship between the centers of microlenses and light condensing spots and the corresponding transmission regions in the liquid crystal display apparatus of FIG. 1.

[FIG. 13] A plan view diagrammatically showing an undesired example of the positional relationship between the centers of microlenses and light condensing spots and the corresponding transmission regions in the liquid crystal display apparatus of FIG. 1.

[FIG. 14] A plan view diagrammatically showing another undesired example of the positional relationship between the centers of microlenses and light condensing spots and the corresponding transmission regions in the liquid crystal display apparatus of FIG. 1.

[FIG. 15] A plan view diagrammatically showing an example of the positional relationship between the centers of microlenses and light condensing spots and the corresponding transmission regions in the case that pixel elements are arranged in a delta pattern.

[FIG. 16] A plan view diagrammatically showing an example of the positional relationship between the centers of microlenses and light condensing spots and the corresponding transmission regions in the case that only the diameter of microlenses corresponding to transmission regions of pixel elements of one color, among microlenses corresponding to transmission regions of R, G and B pixel elements, is selectively made large.

[FIG. 17] A diagrammatic view of a lighting device used for the semi-transmissive liquid crystal display apparatus of FIG. 1.

[FIG. 18] A graph showing the measurement results of an optical characteristic of the lighting device at its light outgoing face.

[FIG. 19] A diagrammatic view for explaining a method for measuring the optical characteristic of the lighting device at its light outgoing face.

[FIG. 20] (a) A view diagrammatically showing the variations in directivity shown in FIG. 18, and (b) A view for explaining the ellipse shown in (b).

[FIG. 21] A view illustrating a light guide plate of the lighting device.

[FIG. 22] A plan view of a TFT substrate of a semi-transmissive liquid crystal display panel used for the semi-transmissive liquid crystal display apparatus of FIG. 1.

[FIG. 23] A cross-sectional view taken along line III-III′ in FIG. 22.

[FIG. 24] A diagrammatic view illustrating a stripe arrangement.

### DESCRIPTION OF REFERENCE NUMERALS

1 Scanning signal line
2 Data signal line
4 Pixel element electrode
5 TFT
5a Semiconductor layer
6 Gate electrode
7 Source electrode
7a Semiconductor contact layer
8 Drain electrode
8a Semiconductor contact layer
9 Contact hole
10 First substrate
11 Second substrate
12 Gate insulating film
13, 13A, 13B Transparent electrodes
14 Interlayer insulating film
15, 15A, 15B Reflection electrodes
16A Red (R) color filter
18 Counter electrode (transparent electrode)
21 LED
22 Prism
22a Reflection plane
23 Liquid crystal layer
24 Light guide plate
24t Corner portion
25 Prism sheet
28 Transparent substrate
29 Transparent substrate
30 Reflector
33 Transparent electrode region
35 Reflection electrode region
41 Light
41c Center of light condensing spot
41f Converging point of light from lighting device
50 Lighting device
54 Microlens array
54a Microlens
54ac Center of microlens 54a
55a Microlens
55ac Center of microlens 55a
56a Microlens
56ac Center of microlens 56a
57a Microlens
57ac Center of microlens 57a
61 Concave portion formed in data signal line
62 Convex portion formed in transparent electrode
63, 74 Portions wider in distance between 2 data signal lines
64A, 64B, 76A, 76B Convex portions formed in transparent electrode
65, 71 Portions narrower in distance between 2 data signal lines
66A, 66B, 73A, 73B Concave portions formed in transparent electrode
67A, 67B, 77A, 77B Cuts formed in reflection electrode
68A, 68B, 75A, 75B Concave portions formed in data signal line
69A, 69B, 72A, 72B Convex portions formed in data signal line
84 Refracting element
100 Semi-transmissive liquid crystal display panel
100A TFT substrate
100B Color filter substrate (counter substrate)
200 Semi-transmissive liquid crystal display apparatus
241c Center of light condensing spot
254a Microlens
254ac Center of microlens 254a
255a Microlens
255ac Center of microlens 257a
400 Liquid crystal display apparatus
Tr Transmission region
Rf Reflection region
Px Pixel element
P1 Pitch of pixel elements in the row direction
P2 Pitch of pixel elements in the column direction
A Opening of reflection electrode

### BEST MODE FOR CARRYING OUT THE INVENTION

For improving the luminance of a display apparatus using condensing elements such as microlenses, the inventers of the present invention have made examination with a particular emphasis on the relationship between the light distribution characteristic (parallelism or directivity) of light outputted from a lighting device and the position of the converging point of the light outputted from the lighting device. As a result, it has been found that the use efficiency of light from the lighting device can be enhanced by forming the converging point of light incident from the lighting device, not at a position in a transparent electrode provided on a substrate (TFT substrate, for example) placed closer to the lighting device or in a display medium layer (liquid crystal layer, for example) of a pixel element, but at a position closer to the observer with respect to the display medium layer. This holds even in the case of using light comparatively high in parallelism, in which the half-value angle of light outputted from a lighting device and incident on a condensing element is ±50 or less, or further ±3.5° or less, and the light use efficiency also improves. In the technical common sense assuming use of parallel light rays, it is considered most preferred to form the focus of a condensing element at the center of the corresponding pixel element, that is, at a position in the display medium layer. The present inventors have however found that the light use efficiency can be improved by shifting the focus to a position closer to the observer with respect to the display medium layer even in the case of using light comparatively high in parallelism, and based on the findings, reached the present invention.

### Embodiment 1

The display apparatus of this embodiment includes: a lighting device for outputting light to the front; a display panel provided with a plurality of pixel elements arranged in a matrix; and a plurality of condensing elements placed between the lighting device and a display panel. The display panel includes a first substrate, a second substrate and a display medium layer provided between the first and second substrates. The first substrate is placed on the side of the display medium layer facing the lighting device, and the second substrate is placed on the observer side of the display medium layer. Each of the plurality of pixel elements has a transmission region for display in the transmission mode using light incident from the lighting device. The first substrate has a transparent electrode region defining at least the transparent region on the surface facing the display medium layer. Each of the plurality of condensing elements is placed in correspondence with the transparent region of each of the plurality of pixel elements. The display apparatus of this embodiment having the above configuration is characterized in that each of the condensing elements is placed so that the converging point of light outputted from the lighting device is formed at a position closer to the observer with respect to the display medium layer.

The display apparatus of Embodiment 1 of the present invention will be described with reference to the relevant drawings.

Hereinafter, this embodiment will be described as being a semi-transmissive (transmissive/reflective) liquid crystal display apparatus, and this also applies to embodiments to follow. Note however that this embodiment is not limited to this type of display apparatus, but will also be applied favorably to various types of liquid crystal display apparatuses other than the semi-transmissive type, such as a transmissive liquid crystal display apparatus. Also, this embodiment will be applied favorably to display apparatuses having a display medium layer other than the liquid crystal layer, such as an electrophoresis display apparatus having an electrophoresis layer.

FIG. 1 is a perspective view diagrammatically showing a semi-transmissive liquid crystal display apparatus 200 of this embodiment.

Referring to FIG. 1, the semi-transmissive liquid crystal display apparatus 200 includes a lighting device (not shown), a display panel 100 provided with a plurality of pixel elements Px arranged in a matrix, and a condensing element group 54 provided between the lighting device and the display panel 100.

The display panel 100 includes a first substrate 10 such as an active matrix substrate placed on the side closer to the lighting device, a second substrate 11 such as a color filter substrate placed on the side closer to the observer, and a liquid crystal layer 23 provided between the first substrate 10 and the second substrate 11.

The first substrate 10 has transparent electrode regions 33 (see FIG. 2) transmitting light 41 outputted from the lighting device and reflection electrode regions 35 (see FIG. 2) reflecting light incident from the second substrate 11 (ambient light, not shown). The first substrate includes transparent electrodes 13 and reflection electrodes 15 (see FIG. 2) provided on the surface thereof facing the liquid crystal layer 23. Each of the reflection electrode regions 35 is defined by a reflection electrode 15, and each of the transparent electrode regions 33 is defined as a region corresponding to an opening of the reflection electrode 15, of the region in which a transparent electrode 13 is formed. The transparent electrode 13 may be provided only in the transparent electrode region. However, by providing the transparent electrode 13 roughly over the entire pixel element as in the illustrated example, the subsequent process can be advantageously stabilized.

The display panel 100 further has the color filter layer including red (R) color filters, green (G) color filters and blue (B) color filters not shown. These R, G and B color filters are arranged in stripes as shown in FIG. 24. Three pixel elements Px adjacent in the row direction, respectively outputting R, G and B color light beams in response to the color filters, constitute one pixel.

Each pixel element Px has a transmission region Tr for display in the transmission mode and a reflection region Rf for display in the reflection mode, enabling display in the transmission mode and the reflection mode. Display in either the transmission mode or the reflection mode or display in both modes is available. The plurality of pixel elements Px arranged in a matrix include pixel elements respectively outputting R, G and B color light beams. Each pixel element Px is defined by light shading layers BL1 extending in the row direction and light shading layers BL2 extending in the column direction. The light shading layers BL1 may be composed of scanning signal lines (see FIG. 22), for example, and the light shading layers BL2 may be composed of data signal lines 2 (see FIG. 22), for example.

As used herein, the transparent electrode regions 33 and the reflection electrode regions 35 are defined as regions on the active matrix substrate such as the TFT substrate, while the pixel elements Px, the transmission regions Tr and the reflection regions Rf are defined as regions of the semi-transmissive liquid crystal display apparatus 200.

The condensing element group 54 of the semi-transmissive liquid crystal display apparatus 200 is composed of a plurality of condensing elements 54a, which are provided in one-to-one correspondence with the transmission regions Tr of the pixel elements Px. In this embodiment, a microlens array 54 having a plurality of microlenses (condensing elements) 54a is used.

In the plurality of microlenses 54a of the microlens array 54 provided in one-to-one correspondence with the plurality of transmission regions Tr, the center of a light condensing spot of a light pencil 41 having passed through each microlens 54a on the plane defined by portions of the liquid crystal layer of a plurality of pixel elements (hereinafter, this plane is sometimes called the “pixel element plane”, which is parallel to the substrate plane) is located in the portion of the liquid crystal layer of the corresponding transmission region Tr.

Herein, the term “light condensing spot” is used as distinguished from the point at which the cross-sectional area of a light pencil is smallest, that is, the converging point (corresponding to the focus of a microlens, for example). The “light condensing spot” corresponds to the cross-sectional profile of light on the pixel element plane and does not necessarily agree with the converging point. The “center of the light condensing spot”, which is a center considering the intensity distribution of light on the pixel element plane, corresponds to the center of gravity of a sheet of paper having an outline corresponding to the cross-sectional profile of the light condensing spot and having a density distribution corresponding to the intensity distribution of light. If the intensity distribution of light is symmetric with respect to the geometrical center of gravity of the cross-sectional profile of the light condensing spot, the “center of the light condensing spot” agrees with the geometrical center of gravity. If the intensity distribution is asymmetric due to the influence of an aberration of the microlens and the like, the center may be deviated from the geometrical center of gravity.

The semi-transmissive liquid crystal display apparatus 200 is characterized in that the converging point of light that has passed through a transparent electrode region of the first substrate is formed at a position closer to the observer with respect to the display medium layer, and with this, the use efficiency of light from the lighting device is enhanced.

As described earlier, in the conventional display apparatuses, the converging point of a condensing element is formed at a position in the transparent electrode region 33 on the first substrate 10 (Patent Literature 2 and 3) or at a position in the portion of the liquid crystal layer 23 of the pixel element. The configurations are therefore different from that in this embodiment.

Hereinafter, a preferred position at which light outputted from the lighting device should be converged will be described specifically with reference to FIGS. 2 and 3. FIG. 2 is a diagrammatic view illustrating the focus position (position of the converging point) of each microlens 54a in the display apparatus 200 of FIG. 1.

As shown in FIG. 2, light 41 outputted from the lighting device (not shown) such as a backlight is condensed by the microlens 54a. The condensed light 41 passes through the transparent electrode region 33 on the first substrate 10 and forms a converging point 41f at a position on the side of the liquid crystal layer 23 where the second substrate 11 is formed.

To state more specifically, when the distance from the top of the microlens 54a to the converging point 41f of the light 41 is f (this distance may also be called the focal length of the microlens 54a) and the distance from the top of the microlens 54a to the transparent electrode region 33 is d, the ratio of d to f (d/f) is preferably 0.6 or more and 0.9 or less, more preferably 0.7 or more and 0.8 or less.

Next, the reason why it is preferred to set the position of the converging point of light outputted from the lighting device and incident on the display panel as described above, opposing the conventional technical common sense, will be described.

First, with reference to FIG. 3, described will be the results of examination on the relationship between the luminous flux of light passing through the transparent electrode region (hereinafter, called the “transmitted luminous flux”) and (d/f) observed when (d/f) is changed in the range of about 0.4 to 1.2. In this examination, the display apparatus of FIG. 1 described above was used. In this display apparatus, as shown in FIG. 11 to be described later, the microlenses are arranged so that the positions of the centers 41c of light condensing spots formed in any two pixel elements Px adjacent in the row direction are different from each other in the column direction. Preferred placement of the microlenses for improving the light use efficiency will be described later with reference to FIGS. 11 to 24.

The transmitted luminous flux was calculated by a ray tracing method using a computer. The details of the lighting device, the microlenses and the display panel used in this examination are as follows.
Lighting device (light source): backlight device using one LED (parallelism of outgoing light ±3.5°, see FIG. 17 and related description to follow, for example)
Microlenses: refractive index 1.52 (glass), radius of curvature 88 μm
First substrate: refractive index 1.52 (glass), thickness 0.7 mm (700 μm)
Second substrate: refractive index 1.52 (glass), thickness 0.7 mm (700 μm)
Liquid crystal layer: thickness 5 μm
Pixel elements: pitch in row direction (P1) 51 μm, pitch in column direction (P2) 153 μm
Transparent electrode regions on first substrate . . . circle of f42 μm (aperture ratio of transmission regions: about 18%)

For comparison, calculation of the luminous flux of light passing through the transparent electrode region was also made for a display apparatus with no microlenses provided.

The ratio of the transmitted luminous flux with microlenses provided to that with no microlenses provided (hereinafter, sometimes abbreviated as the “transmitted luminous flux ratio”) was then calculated. The transmitted luminous flux ratio represents the increase rate of the light use efficiency attained by providing microlenses. A greater value of the transmitted luminous flux ratio means a higher light condensing efficiency of the microlenses.

Further, the size of the transparent electrode region was varied to calculate the transmitted luminous flux ratios obtained when the region was a circle having a diameter of 10 μm (aperture ratio of the transmission region: about 1%), a circle having a diameter of 20 μm (aperture ratio: about 4%) and a circle having a diameter of 30 μm (aperture ratio: about 9%) in the manner described above.

FIG. 3 is a graph showing the relationship between the thus obtained transmitted luminous flux and (d/f).

It is found from FIG. 3 that in any of the sizes of the transparent electrode region on the first substrate varied in the range of φ10 to 42 mm (about 1 to 18% in terms of aperture ratio), the transmitted luminous flux ratio takes a maximum value when (d/f)<1.0.

For example, examining the relationship between the “transmitted luminous flux ratio” and “d/f” observed when the aperture ratio is the largest, i.e., about 18% (x in FIG. 3), the transmitted luminous flux ratio is about 1.9 when (d/f)=1.0. As (d/f) becomes smaller than 1, the transmitted luminous flux ratio becomes greater until reaching the maximum (about 2.2) when (d/f)=0.7. The transmitted luminous flux ratio then gradually decreases after the peak of (d/f) [symbol] 0.7, but is still greater than the value observed when (d/f)=1.0 as long as (d/f) is 0.6 or greater. These results indicate that the light condensing efficiency of the microlens will be greatest when the microlens is formed so that the converging point of light passing through the microlens satisfies (d/f) [symbol] 0.7, and with such microlenses, a display apparatus whose brightness improves by about 2.2 times compared with the case of providing no microlenses and also improves by about 1.2 times compared with the conventional case (d/f [symbol] 1.0) can be obtained.

A similar tendency is also found when the aperture ratio is about 9% (Δ in FIG. 3). To state specifically, the transmitted luminous flux ratio becomes greater as (d/f) becomes smaller than 1, and reaches the maximum (about 2.7) when (d/f)=0.8. The transmitted luminous flux ratio then gradually decreases after the peak of (d/f) [symbol] 0.8, but is still greater than the value observed when (d/f)=1.0 as long as (d/f) is 0.6 or greater. These results indicate that the light condensing efficiency of the microlens will be greatest when the microlens is formed so that the converging point of light passing through the microlens satisfies (d/f) [symbol] 0.8, and with such microlenses, a display apparatus whose brightness improves by about 2.7 times compared with the case of providing no microlens and also improves by about 1.4 times compared with the conventional case (d/f [symbol] 1.0) can be obtained. Note that the above experimental data is also used in Prototype Example 1 to be described later.

As shown FIG. 3, there is recognized a tendency that as the aperture ratio decreases to about 4% (□ in FIG. 3) and further to about 1% (∘ in FIG. 3), (d/f) at which the transmitted luminous flux ratio is greatest is closer to 1.0. For example, when the aperture ratio is about 4%, the transmitted luminous flux ratio gradually decreases after the peak of (d/f) [symbol] 0.8 to 0.9, and becomes greater when (d/f) is about 0.7 than the value when (d/f) [symbol] 1.0. Likewise, when the aperture ratio is about 1%, the transmitted luminous flux ratio gradually decreases after the peak of (d/f) [symbol] 0.9, and becomes greater when (d/f) is about 0.85 than the value when (d/f) [symbol] 1.0.

Therefore, although deferring depending on the aperture ratio, the preferable range of (d/f) within which the transmitted luminous flux ratio is at least greater than the value when (d/f) [symbol] 1.0 is roughly 0.6 to 0.9, more preferably 0.7 to 0.8, when the aperture ratio is about 5% or more, for example. When the aperture ratio is less than about 5%, the preferable range of (d/f) is roughly 0.7 to 0.95, more preferably 0.8 to 0.9.

The aperture ratio (φ in FIG. 3) of the transmission region is preferably 40% or less. As this value is smaller, the use efficiency of light from the lighting device is higher, effectively exhibiting the function of this embodiment. Although the lower limit of the aperture ratio is not especially specified, it is preferably 4% or more considering the parallelism of light outputted from the presently available lighting device and the like.

Note that although FIG. 3 shows the results obtained when the parallelism of light outputted from the lighting device (backlight) is ±3.5°, it has been confirmed that similar results are also obtained when the parallelism is varied in the range of ±1° to ±15°, for example.

As described above, the light use efficiency improves by making placement so that the converging point of light is formed at a position closer to the observer with respect to the liquid crystal layer even when the parallelism of the light is high enough to be regarded as roughly parallel light. The parallelism of light outputted from the lighting device and incident on the condensing element is preferably ±5° or less in half-value angle. Although the lower limit thereof is not especially specified, it is preferably roughly ±2° considering the practicability, the fabrication accuracy of the lighting device, the mass-productivity and the like.

In this embodiment, the reason why the light use efficiency enhances by controlling (d/f) to less than 1 is presumed mainly due to the distribution characteristic of light outputted from the lighting device. Hereinafter, referring to FIGS. 4(a) and 4(b), described will be how the light ray pattern after the light is incident on a microlens differs between the case that the light from the lighting device is complete parallel light (light parallel with the normal to the microlens) and the case that the light from the lighting device is diffused light (light having a predetermined tilt from the normal to the microlens).

FIG. 4(a) is a light ray diagram observed when complete parallel light is incident on the microlens, and FIG. 4(b) is a light ray diagram observed when light tilted 10° from the optical axis (half-value angle of ±10°) is incident on the microlens. The length of the lines shown as the light-receiving face in these figures corresponds to the size of the transparent electrode region on the first substrate, which is 42 μm in the illustrated example.

Note that these figures show simple light ray patterns for explaining the above reason, prepared neglecting factors such as the intensity distribution of light from the lighting device that actually exists.

When the light from the lighting device is complete parallel light, light refracted by the microlens converges on a light-receiving face satisfying (d/f)=1.0 as shown in FIG. 4(a). Also, with the light-receiving face having a fixed size (f42 μm), all the light is condensed within the light-receiving face as long as (d/f) is in the range of 0.5 to 1.3. In other words, the size of the light condensing spot is smaller than the size of the light-receiving face. This means that light of the same amount will pass through the opening of the reflection electrode (defining the transparent electrode region), exhibiting the same luminance, at whichever position the opening is placed as long as (d/f) is in the range of 0.5 to 1.3.

Contrarily, when the light from the lighting device is diffused light, light refracted by the microlens travels deviating from the optical axis and forms the converging point at a position outside the light-receiving face satisfying (d/f)=1.0 ((d/f)>1). Thus, the light-receiving face satisfying (d/f)=1.0 is not irradiated with the light having passed through the microlens. If the light-receiving face is placed at a position closer to the microlens ((d/f)<1.0), the deviation from the optical axis of the light ray is comparatively small, allowing part of the light having passed through the microlens to be incident on the light-receiving face. This means that by placing the opening of the reflection electrode at a position closer to the microlens to satisfy (d/f)<1.0, that is, by shifting the converging point of the light having passed through the microlens to a position closer to the observer, the amount of light passing through the opening (transparent electrode region) increases, and thus the luminance in transmission-mode display improves.

As described above, it is found that when complete parallel light is incident on the microlens, the light transmitted amount (transmission intensity) is unchanged at whichever position of (d/f) in the range of 0.5 to 1.3 the opening is placed. When diffused light is incident on the microlens, however, the light transmitted amount (transmission intensity) increases, improving the luminance, when the opening is placed at a position of (d/f)<1.0. Although the relationship between (d/f) and the light condensing efficiency was discussed for the light whose half-value angle is ±10°, this relationship also applies to light having a half-value angle of ±5° or less, or further ±3.5° or less, which is high in parallelism enough to be regarded as approximately parallel light in the conventional technical common sense.

Note that in FIGS. 2 and 4, the converging point 41f of light from the lighting device is depicted as if being one point. The converging point 41f may otherwise be in the shape of a band (line).

### PROTOTYPE EXAMPLE 1

Hereinafter, referring to FIGS. 5 and 6, a prototype example of the liquid crystal display apparatus of Embodiment 1 will be described. This prototype example corresponds to the examination data for the aperture ratio of about 9% (Δ in FIG. 2) described above with reference to FIG. 2. FIG. 6 is a cross-sectional view taken along line II-II′ of FIG. 5(a).

In this prototype example, a display apparatus having a screen diagonal size of 2.4 inches and 320×240×RGB pixels (QXGA) is used, which is also used in Prototype Examples 2 and 3 to be described later.

FIG. 5(a) is a plan view illustrating the TFT substrate of the display apparatus of Prototype Example 1, and FIG. 5(b) is a plan view illustrating the reflection electrodes 15 formed on the TFT substrate shown in FIG. 5(a).

As shown in FIG. 5(a), on the TFT substrate placed are a total of three data signal lines 2A, 2B and 2C. The adjacent data signal lines 2A and 2B, and the adjacent data signal lines 2B and 2C, face each other with a pixel element therebetween. Transparent electrodes 13A and 13b are respectively formed in the region surrounded by the adjacent data signal lines 2A and 2B and scanning signal lines 1 and the region surrounded by the adjacent data signal lines 2B and 2C and the scanning signal lines 1. As shown in FIG. 5(b), reflection electrodes 15A and 15B respectively have an opening A for defining the transmission region of each pixel element and are formed to cover the transparent electrodes 13A and 13B except for the portion in the opening A. The positions of the two openings A formed in the two reflection electrodes 15A and 15B are different from each other in the column direction, and thus the positions of the two transparent electrode regions defined by the openings A of the reflection electrodes 15A and 15B are also different from each other in the column direction.

As shown in FIG. 5(b), the data signal lines 2 and the transparent electrodes 13 are placed with a gap d of 3 μm from each other. Each of the reflection electrodes 15 has an opening A for exposing each of the transparent electrodes 13, and the opening A defines the transparent electrode region on the TFT substrate. Each of the reflection electrodes 15 is in contact with the corresponding transparent electrode 13 inside an opening provided in an interlayer insulating film 14, and partly overlaps the transparent electrode 13.

Consider a case that the width b of the transparent electrode 13 is 36 μm, the width c of the data signal line 2 is 9 μm, the pitch P1 of the pixel elements in the row direction is 51 pμ, the overlap amount g of the reflection electrode 15 and the transparent electrode 13 is 3 μm, and the diameter e of the opening A formed in the reflection electrode 15 is 30 μm. The pitch P1 of the pixel elements in the row direction has the relationship expressed by Equation (1).
P1=e+2×(g+d)+2×(½×c) (1)

The aperture ratio of the transmission region in the above case is calculated in the following manner. First, assuming that the ratio of the width of each pixel element in the row direction to the width thereof in the column direction is 1:3 and that the pitch P1 of the pixel elements in the row direction (51 μm) corresponds with the width of the pixel element in the row direction, the area of the pixel element is
51 μm×(51 μm×3)=7803 μm².
Since the area of the opening A formed in the reflection electrode 15 on the first substrate is
p×(30 μm/2)² [symbol] 706.5 μm²,
the aperture ratio (%) of the transmission region is
(706.5 μm²÷7803 μm²)×100 [symbol] 9.1%.

The brightness (panel front luminance) of the display apparatus during transmission display was measured, and the result was 63 cd/m².

The above results are data obtained when (d/f)=1.0.

Next, in the display apparatus of this prototype example configured as described above, prototype display apparatuses were further fabricated in which the ratio (d/f) described above was varied in the range of about 0.4 to 1.2, to measure the transmitted luminous flux in each prototype. The results are as shown in FIG. 3 (marked Δ) described above.

As shown in FIG. 3, it is found that the transmitted luminous flux ratio increases as (d/f) becomes smaller than 1, and then gradually decreases after the peak of (d/f)=0.8, but a display apparatus high in luminance compared with the case when (d/f)=1.0 is obtained as long as (d/f) is in the range of about 0.6 to 0.9.

Further, in the display apparatus of this embodiment, the ratio (f/P1) of the distance f from the top of each condensing element to the converging point to the pitch P1 of a plurality of pixel elements in the row direction preferably satisfies (f/P1)<6. With this requirement, the viewing angle can be increased to at least 15° enabling viewing of the display apparatus at any angle and thus making the display apparatus very useful as an information display apparatus.

Hereinafter, the reason for the determination of the above requirement will be described with reference to FIG. 7.

FIG. 7 is a graph showing the relationship between the ratio (f/P1) of the distance f from the top of a condensing element to the converging point to the pitch P1 of pixel elements in the row direction and the front luminance or the half-value viewing angle. The front luminance refers to the luminance value obtained when the display apparatus is viewed from the front (in the direction normal to the display plane), and the half-value viewing angle refers to the viewing angle (tilt angle from the normal to the display plane) at which the luminance value obtained when the display apparatus is viewed in a slanted direction is a half of the front luminance.

As shown in FIG. 7, the front luminance and the half-value viewing angle are opposite to each other in the relationship with (f/P1). As the value of (f/P1) is greater, the front luminance (Δ in FIG. 7) increases, but the half-value viewing angle decreases (x in FIG. 7). The straight line defining the front luminance crosses the straight line defining the half-value viewing angle at the point of (f/P1) [symbol] 6.2. The half-value viewing angle is 15° when (f/P1) [symbol] 6.

As described above, it is found that the ratio (f/P1) can be a good indicator for obtaining a half-value viewing angle of a target level, and by controlling the range of the ratio appropriately, a display apparatus responding to the user's requested characteristics can be obtained. That is, when the display apparatus is used for information display, it is preferred to widen the half-value viewing angle to 15° or more to give viewing at any angle. Therefore, the distance f from the top of the condensing element to the converging point is preferably controlled to be six times or less of the row-direction pitch P1 of pixel elements so that the ratio (f/P1) is 6 or less.

Contrarily, when the display apparatus is mainly used for a mobile phone and the like, in which the user is limited to an individual person, the viewing angle is not necessarily large but rather preferably narrowed. Therefore, the distance f from the top of the condensing element to the converging point is preferably controlled to be more than six times of the row-direction pitch P1 of pixel elements so that the ratio (f/P1) is more than 6.

Moreover, the display apparatus of this embodiment preferably further includes light diffusion elements placed on the observer side of the display medium layer. With these elements, the half-value angle of light outputted from the display panel can be widened and thus the viewing angle of the liquid crystal display apparatus can be widened even when a lighting device such as a backlight high in directivity is used.

Hereinafter, an embodiment of the display apparatus provided with such light diffusion elements will be described with reference to FIG. 8. FIG. 8 is a perspective view of a liquid crystal display apparatus used in this embodiment. The liquid crystal display apparatus of FIG. 8 is the same in configuration as the semi-transmissive liquid crystal display apparatus of FIG. 1 except that a microlens array 84 for diffusing light (not shown) outputted from the second substrate 11 is provided on the observer side (also called the outer side) of the second substrate 11. The microlenses 84 may be known microlenses (diffusion lenses).

In the above embodiment, in which the microlenses 84 are formed as light diffusion elements on the observer side of the second substrate 11, the half-value angle of the display panel can be widened to increase the viewing angle of the liquid crystal display apparatus even when a lighting device such as a backlight high in directivity is used. In particular, by combining a lighting device high in directivity with the liquid crystal display apparatus of this embodiment, bright images excellent in contrast can be widened with the light diffusion elements, to provide a liquid crystal display apparatus having a wide viewing angle range.

Examples of the light diffusion elements used in the above embodiment include diffusing lenses such as microlenses and lenticular lenses, and light refraction elements represented by prisms. Dazzling elements (light diffusion layers or light scattering layers) may otherwise be adopted. Examples of methods for providing dazzling elements include a method in which the surface of a substrate is roughened, a method in which particles (filling agent) having a refractive index different from that of a matrix are scattered in the matrix, and the like.

In the above embodiment, the light diffusion elements were placed on the outer side of the second substrate. The placement of the light diffusion elements is not limited to this, but may at least be made on the observer side of the display medium layer. Accordingly, the light diffusion layers may be placed on the outer side of the second substrate, as in this embodiment, or may be placed on the side of the second substrate facing the liquid crystal layer (this side is also called the inner side). Which configuration should be adopted may be appropriately determined depending on the use of the liquid crystal display apparatus considering merits and drawbacks of these configurations to be described below.

The configuration with the light diffusion layers placed on the inner side has a merit of being less likely to cause blurring of a displayed image (phenomenon in which the profile loses clarity), but has a drawback that the fabrication process is complicated and increases the cost. In a configuration in which the light diffusion layers are selectively placed in the reflection regions, light interference (moiré) is likely to occur if the pitch of the placement pattern of the light diffusion layers is close to the pixel pitch. This problem is eminent in a high-definition liquid crystal display apparatus.

The configuration with the light diffusion layers placed on the outer side has a merit of being easy in fabrication, easily adaptable to design change and sharing and low in fabrication cost, but has a drawback of being likely to cause blurring of a displayed image. To suppress blurring of a displayed image, a thin substrate is preferably used. Placement of a light diffusion layer on the outer side will not cause the problem of ghost that will arise when a reflection layer is placed on the outer side of the substrate. The reason is that unlike the reflection layer, the light diffusion layer does not cause regular reflection of incident light.

Hereinafter, for the purpose of clarifying the usefulness of the display apparatus of this prototype example that additionally includes the light diffusion elements placed on the observer side of the display medium layer, a prototype display apparatus was fabricated in the following manner and compared in power efficiency (panel front luminance/current value of LED) with a presently available type of display apparatus (comparative example).

First, as the display apparatus of this prototype example, a backlight (one LED; current value of LED 30 mA, luminance half-value angle ±3.5°, front luminance 10000 cd/m²) shown in FIG. 17 was provided on the back face of the first substrate in the liquid crystal display apparatus shown in FIG. 1. Also provided were microlenses as the light diffusion elements on the back face of the second substrate, to increase the viewing angle giving a half of the panel front luminance (half-value viewing angle) to as large as ±20°. The configuration of the data signal lines and the like are the same as those in Prototype Example 3 to be described later. The microlenses provided to face the front face (light outgoing face) of the backlight were arranged in a zigzag pattern so that two rows of the centers of light condensing spots different in the position in the column direction were formed in one row of pixel elements, as shown in FIG. 11 (described later).

For comparison, a conventional lighting device provided with three LEDs was placed in a presently available type of display apparatus having no light diffusion elements. In other words, a backlight (three LEDs; current value of LED 45 mA, luminance half-value angle ±25° front luminance 1800 cd/m²) currently used for a general liquid crystal display apparatus was provided on the back face of the first substrate, to increase the half-value viewing angle of the panel front luminance to as large as ±25°.

The panel front luminance was then measured for the above display apparatuses in which the half-value viewing angles of the panel front luminance were made roughly equal to each other as described above, to thereby calculate the power efficiency (panel front luminance/current value of LED). As the lighting device for the display apparatus of this prototype example, a lighting device provided with a single LED and outputting light high in directivity as shown in FIG. 17 was used.

Table 1 shows the results of the power efficiency in this prototype example and the comparative example.

TABLE 1

| | | |
|---|---|---|
| Panel front luminance | 55 | 110 |
| [cd/m²] | | |
| Efficiency | 0.34 (100%) | 1.02 (300%) |
| [cd/m²/mW] | | |
| Half-value viewing | ±25° | ±20° |
| angle | | |
| Backlight front | 1800 | 10000 |
| luminance [cd/m²] | | |
| Luminance half-value | ±25° | ±3.5° |
| angle | | |
| LED current value | 45 | 30 |
| [mA] | | |

As shown in Table 1, while the panel front luminance of this prototype example is as high as 110 cd/m², increased to about twice the panel front luminance (55 cd/m²) of the comparative example having no microlenses, the LED current value is as low as 30 mA, reduced to about two-thirds of that (45 mA) of the comparative example. As a result, this prototype example has increased in power efficiency about three times compared with the comparative example.

As described above, according to this prototype example, it is possible to obtain a display apparatus in which the luminance is enhanced to about twice even if a light source lower in power consumption is used and the life is dramatically enhanced to about three times, compared with the comparative example.

### Embodiment 2

A display apparatus of Embodiment 2 of the present invention will be described with reference to FIGS. 9(a) and 9(b). FIG. 9(a) is a plan view illustrating a TFT substrate of the display apparatus of this embodiment, and FIG. 9(b) is a plan view illustrating reflection electrodes formed on the TFT substrate shown in FIG. 9(a). The TFT substrate and the reflection electrodes used in this embodiment are the same in configuration as those in FIGS. 5(a) and 5(b) referred to in Embodiment 1 described above, except that the width of the data signal lines is changed as described below. In FIGS. 9(a) and 9(b), therefore, the same reference numerals as those in FIGS. 5(a) and (5b) are used.

As shown in FIG. 9(a), in this embodiment, a pair of sides of the adjacent data signal lines 2A and 2B facing each other via a pixel element have a pair of concave portions 61A dented in the row direction. A transparent electrode region is formed at the position corresponding to the pair of concave portions 61A. To state more specifically, the transparent electrode 13A has convex portions at positions corresponding to the pair of concave portions 61A formed on the pair of sides. Likewise, a pair of sides of the adjacent data signal lines 2B and 2C facing each other via a pixel element have a pair of concave portions 61B dented in the row direction. A transparent electrode region is formed at the position corresponding to the pair of concave portions 61B. To state more specifically, the transparent electrode 13B has convex portions at positions corresponding to the pair of concave portions 61B formed on the pair of sides. The reflection electrodes 15A and 15B have cuts 67A and 67B at positions corresponding to the openings A.

In this embodiment, the opening is widened by the areas corresponding to the convex portions 62 formed on the transparent electrode 13. This increases the aperture ratio of the transmission region and thus provides brighter display than in Embodiment 1.

In the display apparatus of this embodiment, two data signal lines facing each other have a “pair of concave portions”. This embodiment is not limited to this, but at least one of a pair of sides facing each other via a pixel element may have a concave portion dented in the row direction. Even with this configuration, the opening A formed in the reflection electrode will be greater, improving the luminance of the pixel element.

For the purpose of further improving the luminance, a condensing element is preferably provided for each of the pixel elements of the display apparatus (details will be described later). For example, as shown in FIG. 11, the condensing elements may be arranged so that the positions of the light condensing spots formed for any adjacent pixel elements in a row of pixel elements are different from each other in the column direction. With this arrangement, the use efficiency of light from the lighting device can be enhanced without constraints of the arrangement of pixel elements.

### PROTOTYPE EXAMPLE 2

Hereinafter, a specific prototype example of Embodiment 2 will be described. This prototype example is the same in configuration as Prototype Example 1 described above, except that the width of portions of the data signal lines corresponding to the transparent electrode regions is reduced to 5 μm.

The aperture ratio (%) of the transmission region in this prototype example is calculated in the manner described in Prototype Example 1. In this prototype example, the values P1, g and d constituting Equation (1) above are the same as in Prototype Example 1, but the width c of the data signal lines is 5 μm. By substituting these values into Equation (1), the diameter e of the opening A of the reflection electrode 15 in this prototype example is
e=34 μm.
Since the area of the opening A formed in the reflection electrode 15 on the first substrate is
π×(34 μm/2)² [symbol] 907.46 m²,
the aperture ratio (%) of the transmission region is
(907.46 μm²÷7803 μm²)×100 [symbol] 11.6%.

In other words, in this prototype example, the aperture ratio of the transmission region can be increased to about 1.3 times compared with Prototype Example 1 (aperture ratio about 9.1%) described above.

Also, the brightness (panel front luminance) during transmission display was measured for the liquid crystal display apparatus of this prototype example. The result was 80 cd/m², increased by about 27% compared with the brightness (63 cd/m²) of Prototype Example 1.

The above results are data obtained when (d/f)=1.0.

In the display apparatus of this prototype example having the above configuration, by controlling (d/f) in the range of about 0.6 to 0.9, it is further possible to provide a display apparatus higher in luminance than that obtained when (d/f)=1.0. This has been confirmed by experiment (not shown).

In this prototype example, also, the microlenses are placed for the respective pixel elements of the display apparatus as shown in FIG. 2. However, with no microlenses provided, the luminance of the pixel elements can be improved by adopting the configuration of the data signal lines described above. This has also been confirmed by experiment.

### Embodiment 3

A display apparatus of Embodiment 3 of the present invention will be described with reference to FIGS. 10(a) and 10(b). This embodiment is different from Embodiment 2 described above in that while the width of the data signal lines was changed in Embodiment 2, the width of the data signal lines is not changed but fixed, and the distance between the data signal lines facing each other via a pixel element is changed in this embodiment. Since the two embodiments are basically the same in the configuration of the TFT substrate, description on the placement of the data signal lines, the positions of the transparent electrode regions and the openings, and the like is omitted here.

FIG. 10(a) is a plan view illustrating the TFT substrate of the display apparatus of this embodiment, and FIG. 10(b) is a plan view illustrating reflection electrodes for defining the reflection electrode regions on the TFT substrate shown in FIG. 10(a). The TFT substrate and the reflection electrodes used in this embodiment are the same in configuration as those in FIGS. 5(a) and 5(b) referred to in Embodiment 1 described above, except that the distance between the data signal lines facing each other via a pixel electrode is changed as described below. In FIGS. 10(a) and 10(b), therefore, the same reference numerals as those in FIGS. 5(a) and 5(b) are used.

As shown in FIG. 10(a), the two adjacent data signal lines 2A and 2B, among a total of three data signal lines 2A, 2B and 2C arranged in a row direction, have a portion 63 curved so that the distance therebetween is wider than in the other portions. A transparent electrode region is formed at the position corresponding to concave portions 68A and 68B formed by the curved portion 63. To state more specifically, the transparent electrode 13A has convex portions 64A and 64B at positions corresponding to the concave portions 68A and 68B formed on the data signal lines 2A and 2B. Opposite to the portion 63 curved so that the distance between the two adjacent data signal lines 2A and 2B is widened, the adjacent data signal lines 2B and 2C have a portion 71 curved so that the distance therebetween is narrowed. The transparent electrode 13B has concave portions 73A and 73B at positions corresponding to convex portions 72A and 72B formed by the curved portion 71.

The two adjacent data signal lines 2A and 2B further have a portion 65 curved so that the distance therebetween is narrower than in the other portions. The transparent electrode 13A has concave portions 66A and 66B at positions corresponding to convex portions 69A and 69B formed by the curved portion 65. Opposite to the portion 65 curved so that the distance between the two adjacent data signal lines 2A and 2B is narrowed, the adjacent data signal lines 2B and 2C have a portion 74 curved so that the distance therebetween is widened. The transparent electrode region is formed at the position corresponding to concave portions 75A and 75B formed by the curved portion 74. To state more specifically, the transparent electrode 13A has convex portions 76A and 76B at positions corresponding to the concave portions 75A and 75B formed on the data signal lines 2B and 2C.

The reflection electrodes 15A and 15B have cuts 67A and 67B at positions corresponding to the openings A.

As described above, in this embodiment, two adjacent data signal lines are formed in a meander pattern so that they have both a portion curved so that the distance therebetween is wider than the other portions and a portion curved so that the distance therebetween is narrower than the other portions. This increases the aperture ratio of the transmission region and thus improves the luminance. The display apparatus of this embodiment is especially useful in the case that the resistance value of a material constituting the data signal lines 2 is so high that a display failure may occur when the width of the data signal lines 2 is narrowed as in Embodiment 2.

In this embodiment, the two data signal lines have both a portion wider in the distance therebetween and a portion narrower in the distance therebetween. The configuration of the data signal lines is not limited to this, but may only have a portion curved so that the distance therebetween is wider than in the other portions. In a display apparatus having this configuration, the opening A in the reflection electrode is widened and thus the luminance of the pixel element improves.

For the purpose of further improving the luminance, a condensing element is preferably provided for each of the pixel elements of the display apparatus. For example, as shown in FIG. 11, the condensing elements may be arranged so that the positions of the light condensing spots formed for any adjacent pixel elements in a row of pixel elements are different from each other in the column direction. With this arrangement, the use efficiency of light from the lighting device can be enhanced without constraints of the arrangement of pixel elements.

### PROTOTYPE EXAMPLE 3

Hereinafter, a specific prototype example of Embodiment 3 will be described.

In this prototype example, used was the same display apparatus as that of Prototype Example 1 described above, except that the width of the data signal lines was not changed but fixed and any two adjacent data signal lines have a portion wider in the distance therebetween in the row direction and a portion narrower in the distance therebetween. That is, among the parameters (P1, g, d and c) constituting Equation (1) above, g and d are the same as in Prototype Example 1, c is 9 μm, and P1 in the portion wider in the distance in the row direction is 56 mm.

By substituting these values into Equation (1), the diameter e of the opening A of the reflection electrode is determined as in Prototype Example 1 as
e=35 μm.

The aperture ratio of the transmission region is then calculated as in Prototype Example 1 to give about 12.3%. The brightness of the display apparatus is also calculated in a similar way to obtain about 85 cd/m².

In other words, in this prototype example, the aperture ratio of the transmission region and the luminance can be enhanced by about 1.4 times and about 35%, respectively, compared with those in the conventional example (aperture ratio of the transmission region about 11.6%, luminance about 63 cd/m²). These results exceed the results of Prototype Example 2 described above.

The above results are data obtained when (d/f)=1.0.

Further, in the display apparatus of this prototype example having the above configuration, by controlling (d/f) in the range of about 0.6 to 0.9, it is possible to provide a display apparatus higher in luminance than that obtained when (d/f)=1.0. This has been confirmed by experiment (not shown).

In this prototype example, also, the microlenses are placed for the respective pixel elements of the display apparatus as shown in FIG. 2. However, with no microlenses provided, the luminance of the pixel elements can be improved by adopting the configuration of the data signal lines described above. This has also been confirmed by experiment.

The results of Prototype Examples 1 to 3 are summarized in Table 2.

TABLE 2

| | | | Gap | | Dia- | |
|---|---|---|---|---|---|---|
| | | | between | | meter | |
| | | | Data | | of | |
| | Pixel | Width | signal | | opening | |
| | element | of | line and | | of | |
| | pitch | data | trans- | | reflect- | |
| | (II-II′ | signal | parent | Overlap | ion | Aperture |
| | portion) | line | electrode | amount | elec- | ratio |
| | P1 | c | d | G | trode | (ratio) |
| Prototype | 51 | 9 | 3 | 3 | 30 | 9.1% |
| Example 1 | | | | | | (100) |
| Prototype | 51 | 5 | 3 | 3 | 34 | 11.6% |
| Example 2 | | | | | | (127) |
| Prototype | 56 | 9 | 3 | 3 | 35 | 12.3% |
| Example 3 | | | | | | (135) |

[unit: μm]

In the display apparatuses of the embodiments described above, the condensing elements may be preferably placed in a predetermined arrangement, so that the positions of the light condensing spots formed in any two pixel elements adjacent in the row direction, among a plurality of pixel elements, are different from each other in the column direction.

Note that the center of gravity of a light condensing spot will agree with the center of the light condensing spot if one light condensing spot center is formed in one pixel element. If two or more light condensing spot centers are formed in one pixel element, the center of gravity will be the center of gravity of such a plurality of light condensing spot centers.

Hereinafter, referring to FIGS. 11 to 16, the features of the arrangement of the microlens array in the liquid crystal display apparatus of this embodiment will be described in more detail. FIGS. 11 to 16 are views observed in the direction normal to the display plane, and show the case in which the center of each microlens agrees with the center of the corresponding light condensing spot.

FIG. 11 is a plan view diagrammatically showing an example of the positional relationship between the centers 41c of the microlenses 54a and light condensing spots and the corresponding transmission regions Tr in the liquid crystal display apparatus 200. A plurality of pixel elements are arranged in stripes with a pitch P1 in the row direction and a pitch P2 in the column direction. Three pixel elements Px adjacent in the row direction respectively outputting R, G and B color light rays constitute one pixel. The plurality of microlenses 54a are placed so that the centers 41a of the corresponding light condensing spots are formed in the transmission regions Tr and roughly agree with the centers of the transmission regions Tr. FIG. 11 shows an example of close-packed arrangement of microlenses for pixel elements arranged in stripes.

Since one center 41c of a light condensing spot is formed for each pixel element Px, the center 41c of the light condensing spot agrees with the center of gravity of the light condensing spot. The centers 41c of the light condensing spots are located in a zigzag pattern in each row of pixel elements. The centers 41c of the light condensing spots formed in any two pixel elements Px adjacent in the row direction are different from each other in the position in the column direction. The light condensing spot centers 41c do not exist at positions that agree with each other in the column direction. In this way, by arranging the microlenses for any adjacent pixel elements in a row of pixel elements so that the centers thereof (light condensing spot centers) are different from each other in the column direction, the microlenses can be put in close-packed arrangement even for pixel elements arranged in stripes.

As shown in FIG. 11, the centers 41c of the light condensing spots are arranged in a zigzag pattern so as to form two rows different in position in the column direction in one row of pixel elements. The pitch Mx of the light condensing spot centers 41c in the row direction in each row of light condensing spot centers 41c is 2P1, and the two rows of light condensing spot centers 41c in the same pixel element row deviate in pitch from each other by (½)Mx (=P1). Since placement is made in this case so that the pitch P2 of the pixel elements in the column direction and the pitch My of the light condensing spot centers 41c in the column direction satisfy the relationship P2=2My, the microlenses 54a circular in a cross section parallel to the display plane exhibit idealistic close-packed arrangement. The microlenses 54a shown in FIG. 11 satisfy the relationship Mx:My=2:v3, and the packing fraction of the microlenses 54a on the microlens array plane (plane parallel to the display plane) is pv3/6=0.906, which is greatest. This indicates that 90.6% of the light amount incident on the liquid crystal panel 100 from the lighting device 50 can be condensed, guided to the corresponding transmission regions and used for display. Thus, even though the area of the transmission regions decreases with the achievement of higher definition of the liquid crystal panel, bright transmission-mode display can be attained. Bright transmission-mode display can also be attained even if the area ratio of the transmission region to each pixel element Px is reduced to improve the luminance in the reflection mode. Also, the ratio of the display luminance in the reflection mode to that in the transmission mode can be changed with design of lenses without changing the area ratio for forming the reflection electrode and the transparent electrode.

FIGS. 13 and 14 are diagrammatic views illustrating examples in which the centers of microlenses and light condensing spots are not arranged as shown in FIG. 11.

In the arrangement of microlenses shown in FIG. 13, when the ratio of the pitch P1 of the pixel elements Px in the row direction to the pitch P2 thereof in the column direction is 1:3 that is a general ratio, the packing fraction of microlenses 254a is p/12=0.262 at maximum. Therefore, the light amount usable for transmission-mode display is 26.2% or less of the light amount incident on the liquid crystal display panel from the lighting device.

In FIG. 14 in which three microlenses 255a are placed for each pixel element Px, when P1:P2=1:3, the packing fraction of the microlenses 255a is p/4=0.785 at maximum. Therefore, the light amount usable for transmission display is 78.5% or less of the light amount incident on the liquid crystal display panel from the lighting device.

Although FIG. 11 shows the case that the cross-sectional shape of the lenses on the plane parallel to the display plane is circular, the shape of the lenses used for the liquid crystal display apparatus 200 is not limited to this. The cross-sectional shape of the lenses may be hexagonal, for example, as shown in FIG. 12. In the microlens array shown in FIG. 12, a plurality of microlenses 55a in the shape of a regular hexagon are arranged in a honeycomb pattern. Since each side of the microlenses 55a is designed to be in contact with the corresponding side of an adjacent microlens, the packing fraction of the microlenses 55a in the microlens array plane is substantially 100%. The lens packing fraction is therefore further improved compared with the microlenses 54a shown in FIG. 11, and thus brighter transmission-mode display can be attained.

Although the pixel elements in the liquid crystal display apparatus 200 were arranged in stripes in the above description, the arrangement of the pixel elements Px is not limited to this, but may be in a delta pattern, for example.

FIG. 15 is a plan view diagrammatically showing an example of the positional relationship between the centers 41c of microlenses 56a and light condensing spots and the corresponding transmission regions Tr in the case that pixel elements Px are arranged in a delta pattern. The light condensing spot centers 41c shown in FIG. 15 have substantially the same positional relationship as the light condensing spot centers 41c shown in FIG. 11 although the pixels Px are arranged in a delta pattern.

The above embodiments of the present invention were described taking as examples the cases of close-packed arrangement or like arrangement of the microlenses. The present invention is not limited to this.

A variety of arrangements of microlenses can be made by placing the centers of the microlenses (centers of light condensing spots) for any adjacent pixel elements in a pixel element row at positions different in the column direction, to thereby achieve various effects.

As described above using the close-packed arrangement as an example, the diameter of the microlenses 54a can be made greater than the pitch P1 of the pixel elements Px in the row direction. Therefore, the light use efficiency can be improved using large microlenses without constraints of the pixel element pitch P1.

In the examples in FIGS. 11, 12 and 15, the size of the plurality of microlenses in the row direction was greater than the pitch P1 of the pixel elements Px. The microlenses used in the present invention are not limited to this. Microlenses having a size in the row direction greater than the pixel element pitch P1 provide the effect of permitting more effective condensing of light from the lighting device on the transmission regions, compared with microlenses having a size equal to or less than the pitch P1. However, the size of each microlens may be appropriately determined depending on the ratio of the transmission region to the pixel element Px, the position and the like. It may even be equal to or less than the pitch P1. Even microlenses having a size in the row direction equal to or less than the pitch P1 of the pixel elements Px can provide the effect of permitting change of the ratio of the display luminance in the reflection mode to that in the transmission mode with the design of the lenses without changing the area ratio for forming the reflection electrode and the transparent electrode.

Alternatively, only some of a plurality of microlenses may have a size in the row direction greater than P1. For example, only the size of microlenses corresponding to the transmission regions of pixel elements of one color or two colors, among the R, G and B pixel elements, may be selectively made greater, to increase the luminance of a specific color. In some cases, display easy to view can be attained by changing the luminance of display with the color. Also, when the thicknesses of R, G and B color filters are made the same, the luminance of a given color that may become low can be compensated.

FIG. 16 is a plan view diagrammatically showing an example of the positional relationship between the centers 41c of microlenses 57a and 58a and light condensing spots and the corresponding transmission regions Tr in the case that only the diameter of the microlenses 57a corresponding to transmission regions of pixel elements of one color, among the microlenses 57a and 58a corresponding to the transmission regions of R, G and B pixel elements, is selectively made large. The centers of the light condensing spots of the microlenses shown in FIG. 16 have substantially the same positional relationship as the microlenses 54a shown in FIG. 11.

In FIGS. 11, 12, 15 and 16, the microlenses are spherical lenses and the transmission regions are circular. The type of the microlenses and the shape of the transmission regions are not limited to these. The microlenses may be aspherical lenses or Fresnel lenses, for example. The shape of the transmission regions can be determined appropriately depending on the shape of the light condensing spots, for example.

The microlens array 54 can be formed in a known method. Specifically, the microlens array may be formed in a process described below, for example.

First, a mold master having a desired shape of the lens array 54 formed precisely is prepared. An ultraviolet cure resin is sealed in between the mold master and the substrate 10 of the liquid crystal panel 100. The sealed-in resin is then irradiated with ultraviolet light to be cured. Once the ultraviolet cure resin is completely cured, the mold is removed off gently.

By use of the method described above, a lens array high in optical characteristics can be produced easily with high mass-productivity. As the material of the lens array 54, used favorably is an ultraviolet cure resin high in transparency and small in birefringence in the completely cured state. As methods other than the above method, an ion exchange method and a photolithographic method may be used.

Hereinafter, the lighting device 50 used for the semi-transmissive liquid crystal display apparatus 200 of Embodiment 1 will be described.

(Lighting Device)

The lighting device 50 used in Embodiment 1 is a backlight device using one LED as a light source. To attain sufficient condensing of light from the lighting device with the light condensing elements 54, the parallelism of light incident from the lighting device is preferably high (for example, the half-value width of the luminance of outgoing light is preferably within ±5°. The lighting device 50 described below can output light high in parallelism in a predetermined direction.

As shown in FIG. 17. the lighting device 50 includes a light guide plate 24, a reflector 30 provided on the back face of the light guide plate 24, an LED 21 placed near a corner 24t of the light guide plate 24 (see FIGS. 19 and 20), and a prism sheet 25 provided on the front face of the light guide plate 24. The details of the lighting device 50 used in this embodiment are described in IDW '02 pp. 509-512 (Kalil Kalantar et al).

Light outgoing from the LED 21 is incident on the light guide plate 24 and outgoes from roughly the entire light outgoing face of the light guide plate 24 by being reflected inside the light guide plate. Light outgoing from the bottom face of the light guide plate 24 is reflected by the reflector 30 to reenter the light guide plate 24, and outgoes from the light outgoing face of the light guide plate 24. The light outputted from the light guide plate 24 is incident on the prism sheet 25, which refracts the incident light in the direction normal to the light guide plate 24.

The reflector 30 is made of an aluminum film and the like, for example. The light guide plate 24 is made of a transparent material such as polycarbonate, polymethyl methacrylate and the like. The light guide plate 24 has a plurality of prisms 22 for allowing light incident in the light guide plate 24 to reflect from reflection faces 22a and then outgo outside the light guide plate 24. The plurality of prisms 22, formed on the bottom surface of the light guide plate 24, are arranged in a matrix as shown in FIG. 21. Each prism 22 is configured in a triangular groove shape having two reflection faces 22a as shown in FIG. 17. As shown in FIG. 21, the reflection faces 22a of the prisms 22 are formed to extend in X direction (second direction) perpendicular to Y direction (first direction) that is a radial direction of circles whose center is the LED 21. In other words, the prisms 22 are formed in grooves extending in X direction. The tilt angle of the reflection faces 22a is determined to allow light traveling inside the light guide plate 24 to outgo in the direction normal to the light guide plate 24 efficiently. Note that although the distance between any adjacent prisms 22 is fixed in FIG. 21, it is actually designed to be shorter as the prisms 22 are farther from the LED 21.

FIG. 18 shows the measurement results of an optical characteristic at the light outgoing face of the lighting device 50. The results in FIG. 18 show average values of the luminance measured at three measuring points A, B and C on an arc whose center is the LED 21. The radial direction from the LED 21 is defined as Y direction and the direction perpendicular to Y direction is defined as X direction.

As shown in FIG. 18, while the half-value width of the luminance of outgoing light in X direction is about ±3°, the half-value width of the luminance of outgoing light in Y direction is about ±15°. It is therefore found that there is a difference in directivity between X direction and Y direction: the directivity in X direction is higher than that in Y direction (that is, outgoing light in X direction is higher in parallelism than outgoing light in Y direction). Accordingly, outgoing light has a variation in directivity on the light outgoing face. FIG. 20(a) diagrammatically shows this variation in directivity. The ellipses shown in FIG. 20(a) have the following meaning: as shown in FIG. 20(b), the directivity is weak (the parallelism of outgoing light is low) in the direction of the major axis of the ellipse, and the directivity is strong (the parallelism of outgoing light is high) in the direction of the minor axis thereof.

The light outputted from the lighting device 50 has a difference in directivity between X direction and Y direction on the light outgoing face as described above. The light in X direction high in directivity can be sufficiently condensed by using the microlens array 54 composed of the microlenses 54 (see FIGS. 1 and 11) that are circular in a cross section parallel to the display plane. Therefore, high-luminance display can be achieved roughly over the entire display plane of the liquid crystal display apparatus 200.

The lighting device used in this embodiment is not limited to that described above. For example, the LED 21 may be placed in the center of a side of the light guide plate 24, or two LEDs may be used. Otherwise, in place of the LED, a fluorescent tube, for example, may be used. Note however that since only light incident in the normal direction is used in this example, out of the incident light from the lighting device, a lighting device such as a projector, for example, is excluded.

(Display Panel)

Referring to FIGS. 22 and 23, the general structure and function of the TFT substrate of the display panel 100 used for the semi-transmissive liquid crystal display apparatus 200 of FIG. 1 will be described in detail. FIG. 22 is a plan view of a TFT substrate 10A, and FIG. 23 is a partial cross-sectional view of the display panel 100 having the TFT substrate 10A, taken along line III-III′ in FIG. 22. Note that although this embodiment discloses the active matrix liquid crystal display apparatus using thin film transistors (TFTs), it can also be applied to an active matrix liquid crystal display apparatus using MIM and a simple matrix liquid crystal display apparatus.

As shown in FIG. 23, the display panel 100 includes the TFT substrate 100A (corresponding to the first substrate 10 in FIG. 1), a color filter substrate 100B (corresponding to the second substrate 11 in FIG. 1), and a liquid crystal layer 23 interposed between these substrates. A polarizing plate, a ¼λ plate and an alignment film (all of these elements are not shown) are provided for each of the TFT substrate 100A and the color filter substrate 100B as required.

As shown in FIG. 22, the TFT substrate 100A used for the display panel 100 includes thin film transistors (TFTs) 5, a plurality of scanning signal lines (gate bus lines) 1 and data signal lines (source bus lines) 2 formed on the first substrate 10 (made of glass or quartz, for example). As shown in FIGS. 22 and 23, a transparent electrode 13 made of ITO, for example, and a reflection electrode 15 made of Al, for example, are formed in a region surrounded by the scanning signal lines 1 and the data signal lines 2, and the transparent electrode 13 and the reflection electrode 15 constitute a pixel element electrode 4.

The TFT 5 is formed near a region of intersection between each scanning signal line 1 and each data signal line 2, in which the scanning signal line 1 is connected to a gate electrode 6 and the data signal line 2 is connected to a source electrode 7. Although not shown in FIG. 13, the pixel element electrode 4 may be formed to overlap the scanning signal lines 1 and the data signal lines 2, to provide the effect of permitting enhancement in pixel element aperture ratio.

As shown in FIG. 23, the display panel 100 has a transmission region Tr and a reflection region Rf for each of a plurality of pixel elements Px arranged in a matrix, when viewed from the top (display plane). The transmission region Tr is defined by a region having a function as an electrode for applying a voltage to the liquid crystal layer 23 and a function of transmitting light, among the region of the TFT substrate 100A. The reflection region Rf is defined by a region having a function as an electrode for applying a voltage to the liquid crystal layer 23 and a function of reflecting light, among the region of the TFT substrate 100A.

A gate insulating film 12 is formed on a transparent substrate 28 of the TFT substrate 10A, covering the scanning signal lines 1 (see FIG. 22) and the gate electrode 6. A semiconductor layer 5a is formed on the portion of the gate insulating film 12 located above the gate electrode 6. The semiconductor layer 5a is connected with the source electrode 7 and a drain electrode 8 via semiconductor contact layers 7a and 8a, respectively, to thereby form the TFT 5. The drain electrode 8 of the TFT 5 is electrically connected with the transparent electrode 13 and further electrically connected with the reflection electrode 15 in a contact hole 9 formed through an interlayer insulating film 14. The transparent electrode 13 is formed on the gate insulating film 12 at a position near the center of the region surrounded by the scanning signal lines 1 and the data signal lines 2.

The interlayer insulating film 14 having an opening A (corresponding to an opening of the reflection electrode 15) for exposing the transparent electrode 13 covers roughly the entire surface of the transparent substrate 28. The reflection electrode 15 is formed on the interlayer insulating film 14 around the opening A. The surface of the interlayer insulating film 14 on which the reflection electrode 15 is formed has a continuous wave profile having concave and convex portions. The reflection electrode 15 has a shape tracing this surface profile, exhibiting a moderate diffuse reflection characteristic. The interlayer insulating film 14 having such a continuous wave profile having concave and convex portions can be formed using a photosensitive resin, for example.

The transparent electrode 13 is preferably formed in roughly the entire region surrounded by the data signal lines 2 and the scanning signal lines 1. By forming the transparent electrode 13 so as not to overlap the data signal lines 2 and the scanning signal lines 1, the capacitance formed therebetween can be sufficiently reduced.

The reflection electrode 15 preferably has the opening A for defining the transmission region Tr and is formed to cover the transparent electrode 13 except for the portion in the opening A. In other words, the external fringe of the transparent electrode 13 is preferably located inside the external fringe of the reflection electrode 15. Also, part of the external fringe of the reflection electrode 15 preferably overlaps the two data signal lines 2 and the two scanning signal lines 1 surrounding the pixel element (and further the TFT 5). This can widen the reflection electrode region 35.

Further, preferably, the reflection electrode 15 is formed on the interlayer insulating film 14 formed to cover the data signal lines 2 and the scanning signal lines 1 (and further the TFT 5), and the dielectric constant of the interlayer insulating film 14 is small and/or the thickness of the interlayer insulating film 14 is sufficiently large. With such an interlayer insulating film 14, the capacitance formed between the data signal lines 2/scanning signal lines 1 (and further the TFT 5) and the reflection electrode 15 can be sufficiently reduced, and thus the reflection electrode region 35 can be widened.

Also, the following structure is preferred: the transmission region Tr is formed near the center of each pixel element Px and the reflection region Rf is formed surrounding the transmission region Tr. By placing the reflection region Rf in the periphery portion of the pixel element Px, a configuration allowing part of the reflection region Rf to overlap the data signal lines 2 and the scanning signal lines 1 can be adopted, and this can comparatively widen the area of the reflection region Rf. Also, by placing the transmission region Tr near the center of the pixel element Px, light can be condensed on the transmission region with the condensing element more efficiently. Note that the wording “near the center” as used herein refers to the center portion as opposed to the periphery portion. As shown in FIG. 1, for example, the transmission regions Tr may be placed in a zigzag pattern in the row direction, to improve the light condensing efficiency with the condensing elements.

The thickness (dt) of the portion of the liquid crystal layer 23 in the transmission region Tr and the thickness (dr) of the portion of the liquid crystal layer 23 in the reflection region Rf preferably roughly satisfy the relationship dt=2dr. With this, the path lengths of light used in the reflection mode and light used in the transmission mode can be made identical to each other. Therefore, in a mode of display using a change (rotation) in polarizing direction in the liquid crystal layer 23 (TN mode, STN mode, and ECB mode including a vertical alignment mode), the polarizing direction of light that has passed the reflection region Rf and the polarizing direction of light that has passed the transmission region Tr are made to agree with each other, to thereby enable high-quality display. As a method for controlling the thickness of the liquid crystal layer 23 as described above, proposed is a method of using the thickness (t) of the interlayer insulting film 14 to give a difference (Δd) between the thickness (dt) of the portion of the liquid crystal layer in the transmission region and the thickness (dr) of the portion of the liquid crystal layer in the reflection region. By controlling the thicknesses to give t [symbol] Δd, the relationship described above, “dt=2dr”, can be roughly satisfied.

A color filter layer is formed on a transparent substrate 29 of the color filter substrate 10B, and a counter electrode (transparent electrode) 18 is formed on the surface of the color filter layer facing the liquid crystal layer 23. The color filter layer has red (R) (16A), green (G) and blue (B) color filters and a black matrix 16D provided between these color filters. In the liquid crystal display apparatus 200 of this embodiment, the color filters are arranged in stripes as shown in FIG. 24. The counter electrode 18 is made of ITO, for example.

Note that the display panel used for the semi-transmissive liquid crystal display apparatus 200 is not limited to that described above, but a variety of known panels can be used. The display panel used for the semi-transmissive liquid crystal display apparatus 200 is not limited to a color display type one, but may be of a monochrome type.

### INDUSTRIAL APPLICABILITY

According to the present invention, the use efficiency of light from the lighting device can be enhanced. In particular, the present invention can effectively improve the luminance of a semi-transmissive display apparatus permitting display in the transmission mode and display in the reflection mode. In mobile equipment such as mobile phones, therefore, power consumption can be reduced and thus the number of times of replacement or charging of a battery required can be reduced.

1-17. (canceled)

18. A display apparatus comprising:
a lighting device for outputting light to the front;
a display panel provided with a plurality of pixel elements arranged in a matrix; and
a plurality of condensing elements provided between the lighting device and the display panel,
wherein the display panel includes a first substrate, a second substrate and a display medium layer placed between the first substrate and the second substrate, the first substrate being placed on the side of the display medium layer facing the lighting device, the second substrate being placed on the observer side of the display medium layer,
each of the plurality of pixel elements has a transmission region for display in a transmission mode using light incident from the lighting device, the first substrate having a transparent electrode region defining the transmission region on the side facing the display medium layer, and
each of the plurality of condensing elements is placed to correspond to the transmission region of each of the plurality of pixel elements and placed so as to form the converging point of light outputted from the lighting device at a position closer to the observer with respect to the display medium layer.

19. The display apparatus of claim 18, wherein the ratio (d/f) of a distance d from the top of the condensing element to the transparent electrode region to a distance f from the top of the condensing element to the converging point satisfies
0.6≦(d/f)≦0.9.

20. The display apparatus of claim 19, wherein the ratio (d/f) of a distance d from the top of the condensing element to the transparent electrode region to a distance f from the top of the condensing element to the converging point satisfies
0.7≦(d/f)≦0.8.

21. The display apparatus of claim 18, wherein the ratio (f/P1) of a distance f from the top of the condensing element to the converging point to a pitch P1 of the plurality of pixel elements in the row direction satisfies
(f/P1)<6.

22. The display apparatus of claim 18, wherein the positions of light condensing spots formed for two pixel elements adjacent in the row direction, among the plurality of pixel elements, are different from each other in the column direction.

23. The display apparatus of claim 18, wherein the plurality of condensing elements constitute a microlens array.

24. The display apparatus of claim 18, wherein each of the plurality of pixel elements further has a reflection region for display in a reflection mode using light incident from the observer side, the first substrate having a reflection electrode region defining the reflection region on the side facing the display medium layer,
the first substrate further has a plurality of data signal lines arranged in the row direction,
each of the plurality of pixel elements is placed between two data signal lines adjacent to each other, and
at least one of a pair of sides of the two data signal lines adjacent to each other, the pair of sides facing each other via a pixel element, forms a concave portion dented in the row direction, and at least part of the transparent electrode region is formed at a position corresponding to the concave portion.

25. The display apparatus of claim 24, wherein the first substrate has a transparent electrode and a reflection electrode having an opening placed on the side of the transparent electrode facing the display medium layer, the transparent electrode region being defined by the opening of the reflection electrode, and
the transparent electrode has a convex portion part of which is located inside the concave portion.

26. The display apparatus of claim 24, wherein a pair of sides of the two data signal lines adjacent to each other, the pair of sides facing each other via a pixel element, form a pair of concave portions dented in the row direction, and the transparent electrode region is formed at a position corresponding to the pair of concave portions.

27. The display apparatus of claim 25, wherein the positions of transmission regions of two pixel elements adjacent in the row direction, among the plurality of pixel elements, are different from each other in the column direction, and
the reflection electrode of a given pixel element has a cut at a position corresponding to the transmission region of a pixel element adjacent in the row direction.

28. The display apparatus of claim 18, wherein each of the plurality of pixel elements further has a reflection region for display in a reflection mode using light incident from the observer side, the first substrate having a reflection electrode region defining the reflection region on the side facing the display medium layer,
the first substrate further has a plurality of data signal lines arranged in the row direction,
each of the plurality of pixel elements is placed between two data signal lines adjacent to each other, and
the two data signal lines adjacent to each other have a portion curved so that the distance therebetween is wider than in the other portions, and at least part of the transparent electrode region is formed at a position corresponding to a concave portion formed by the curved portion.

29. The display apparatus of claim 28, wherein the first substrate has a transparent electrode and a reflection electrode having an opening placed on the side of the transparent electrode facing the display medium layer, the transparent electrode region being defined by the opening of the reflection electrode, and
the transparent electrode has a convex portion part of which is located inside the concave portion formed by the curved portion.

30. The display apparatus of claim 29, wherein the positions of transmission regions of two pixel elements adjacent to each other in the row direction, among the plurality of pixel elements, are different from each other in the column direction, and
the reflection electrode of a given pixel element has a cut at a position corresponding to the transmission region of a pixel element adjacent in the row direction.

31. The display apparatus of claim 18, wherein the parallelism of light outputted from the lighting device and incident on the plurality of condensing elements is ±5° or less in half-value angle.

32. The display apparatus of claim 18, wherein the display medium layer is a liquid crystal layer.

33. The display apparatus of claim 18, further comprising a light diffusion element placed on the observer side of the display medium layer.

34. The display apparatus of claim 19, wherein each of the plurality of pixel elements further has a reflection region for display in a reflection mode using light incident from the observer side, and the first substrate further has a reflection electrode region defining the reflection region on the side facing the display medium layer.

35. The display apparatus of claim 19, wherein the lighting device includes a light source and a light guide plate receiving light from the light source, and
the directivity of light, which is output from the lighting device and incident on the plurality of condensing element, in X direction is higher than that in Y direction, where Y direction is a radial direction of circles whose center is the light source and X direction is perpendicular to Y direction.

36. The display apparatus of claim 34, wherein the lighting device includes a light source and a light guide plate receiving light from the light source, and
the directivity of light, which is output from the lighting device and incident on the plurality of condensing element, in X direction is higher than that in Y direction, where Y direction is a radial direction of circles whose center is the light source and X direction is perpendicular to Y direction.

37. Mobile electronic equipment comprising the display apparatus of claim 18.
